(19) United States
(12) Patent Application Publication
(10) Pub. No.: US 2023/0116303 A1
(43) Pub. Date: Apr. 13, 2023

(54) METAL MATERIAL, CONNECTION TERMINAL, AND METHOD FOR PRODUCING METAL MATERIAL

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Ryo KEMMOTSU, Mie (JP); Kingo FURUKAWA, Mie (JP)

(21) Appl. No.: 17/909,606

(22) PCT Filed: Mar. 3, 2021
(86) PCT No.: PCT/JP2021/008189

§ 371 Date: Sep. 6, 2022

(30) Foreign Application Priority Data
Mar. 11, 2020 (JP) 2020-041485

(51) Int. Cl. H01B 1/02; H01R 13/03; H01B 13/00; C25D 5/12; C25D 5/50

(52) U.S. Cl. CPC H01B 1/02; H01R 13/03; H01B 13/0016; C25D 5/12; C25D 5/505; H01R 12/58

(57) ABSTRACT

Provided is a metal material including a substrate and an Ag—Sn covering layer that covers a surface of the substrate, in which the Ag—Sn covering layer contains Ag and Sn and has an Ag—Sn alloy exposed on a surface thereof, and an average crystal grain size in a cross section in parallel with a surface of the Ag—Sn covering layer is less than 0.28 μm. Provided is also a metal material, produced by forming a metal layer including Ag and Sn, on a surface of a substrate, and heating the resultant at a temperature equal to or more than the melting point of Sn, and including an Ag—Sn covering layer containing Ag and Sn and having an Ag—Sn alloy exposed on a surface thereof, on the surface of the substrate.

### TECHNICAL FIELD

The present disclosure relates to a metal material, a connection terminal, and a method for producing a metal material.

### BACKGROUND

Ag-plated terminals may be used as electric connection terminals for large current in automobiles. Ag-plated terminals, while are excellent in heat resistance, corrosion resistance and electric conductivity, have the property of easily causing adhesion due to softness of Ag and thus being easily increased in friction coefficient on surfaces thereof. An increase in friction coefficient on surfaces of electric connection terminals leads to an increase in force necessary for sliding, for example, during insertion and removal into and from counter connection terminals.

One measure for not only utilizing excellent heat resistance and electric conductivity of Ag, but also keeping a low friction coefficient may be formation of Ag—Sn alloy layers. Ag—Sn alloys are harder and also more hardly cause adhesion than Ag, and thus exert the effect of keeping a low friction coefficient on metal material surfaces when in the form of being exposed on outermost surfaces of metal members such as electric connection terminals or in the form of being placed as under layers of other metal layers, such as Ag layers. Metal materials including Ag—Sn alloy layers are disclosed in, for example, Patent Documents 1 to 5 below.

### PRIOR ART DOCUMENT

### Patent Document

Patent Document 1: JP 2008-050695 A
Patent Document 2: JP 2010-138452 A
Patent Document 3: JP 2013-231228 A
Patent Document 4: WO 2015/083547 A1
Patent Document 5: JP 2017-162598 A

### SUMMARY OF THE INVENTION

### Problems to be Solved

Ag—Sn alloy layers are exposed on outermost surfaces of metal members such as connection terminals, and thus the effect exerted by Ag—Sn alloy layers, such as a reduction in friction, can be largely enjoyed. However, Ag—Sn alloy layers can be sulfurized by the sulfur content in the air, to result in black discoloration of surfaces thereof. In particular, after storage and use of metal members for a long time, Ag—Sn alloy layers are easily blackened due to sulfurization. Such blackening due to sulfurization, although hardly has an immediate effect on performances of metal members serving as connection terminals or the like, can cause users or the like to have suspicions about characteristics, and suppression thereof is preferred.

An object is then to provide a metal material and a connection terminal that are hardly blackened due to sulfurization even if an Ag—Sn alloy layer is exposed on the outermost surface, and also to provide a method for producing a metal material, which can produce such a metal material.

### Means to Solve the Problem

A first metal material of the present disclosure comprises a substrate and an Ag—Sn covering layer that covers a surface of the substrate, wherein the Ag—Sn covering layer contains Ag and Sn and has an Ag—Sn alloy exposed on a surface thereof, and an average crystal grain size in a cross section in parallel with a surface of the Ag—Sn covering layer is less than 0.28 μm.

A second metal material of the present disclosure is produced by forming a metal layer including Ag and Sn, on a surface of a substrate, and heating the resultant at a temperature equal to or more than the melting point of Sn, and comprises an Ag—Sn covering layer containing Ag and Sn and having an Ag—Sn alloy exposed on a surface thereof, on the surface of the substrate.

A connection terminal of the present disclosure is constituted from the first metal material or the second metal material, wherein the Ag—Sn covering layer is formed on the surface of the substrate, at least in a contact portion to be in electric contact with a counter conductive member.

A method for producing a metal material of the present disclosure is to produce the first metal material or the second metal material, by forming a metal layer including Ag and Sn, on a surface of a substrate, and thereafter heating the resultant at a temperature equal to or more than the melting point of Sn.

### Effect of the Invention

A metal material and a connection terminal according to the present disclosure are hardly blackened due to sulfurization even if an Ag—Sn alloy layer is exposed on the outermost surface. Such a metal material can be produced by a method for producing a metal material according to the present disclosure.

### BRIEF DESCRIPTION OF THE DRAWINGS

FIG. 1 is a schematic view illustrating a cross section of a metal material according to one embodiment of the present disclosure.

FIG. 2 is a front view illustrating a connection terminal according to one embodiment of the present disclosure.

FIG. 3 is a cross-sectional view illustrating one example of a connector including the connection terminal.

FIGS. 4A and 4B illustrate SEM images (secondary electron images) of surfaces of respective metal materials according to Sample 1 after no reflow heating and Sample 2 after reflow heating. A low-magnification image (20,000×) is illustrated in the upper section and a high-magnification image (50,000×) is illustrated in the lower section.

FIGS. 5A and 5B illustrate crystal grain distribution images by EBSD, of metal materials according to Sample 1 and Sample 2. FIG. 5A illustrates cross sections perpendicular to surfaces and FIG. 5B illustrates cross sections in parallel with such surfaces. Furthermore, FIG. 5C illustrates bar graphs representing grain size distributions in the cross sections in parallel with such surfaces.

FIGS. 6A to 6C illustrate the results of orientation analysis by EBSD, of cross sections in parallel with surfaces of metal materials according to Sample 1 and Sample 2. FIG. 6A illustrates specified orientation distributions and FIG. 6B illustrates plastic strain distributions. FIG. 6C illustrates frequency distributions of deviation angles from specified orientations of Samples 1 and 2.

FIG. 7 illustrates the hardness measurement results of metal materials according to Samples 1 and 2. The measurement results are illustrated respectively in the case of formation of an Ag strike layer and the case of no formation thereof.

FIGS. 8A and 8B respectively illustrate images of a connection terminal according to Sample 1 and a connection terminal according to Sample 2, after a lapse of 155 days under medium temperature conditions.

FIGS. 9A and 9B respectively illustrate SEM images (secondary electron images) by observation of cross sections of metal materials according to Samples 1 and 2, in the initial state and in the state after a lapse of 480 hours under high-temperature and high-humidity conditions.

FIGS. 10A and 10B illustrate the results of depth analysis XPS measurement of metal materials according to Samples 1 and 2, in the initial states. FIG. 10A represents the results in an Ag MVV auger region and FIG. 10B the results in a Sn3d photoelectron region.

FIGS. 11A and 11B respectively illustrate depth distributions of the O, Ag and Sn concentrations of metal materials according to Samples 1 and 2, obtained from depth analysis XPS.

FIGS. 12A and 12B illustrate examples of load displacement curves obtained by measurement in insertion and removal of a terminal into and from a through-hole. FIGS. 12A and 12B respectively illustrate behaviors in terminal insertion and in terminal removal, with respect to Sample 2 after a lapse of 480 hours under high-temperature and high-humidity conditions.

FIGS. 13A to 13C illustrate characteristics of insertion and removal of connection terminals according to Sample 1 and Sample 2, in the initial state and in the states after medium temperature conditions and high-temperature and after high-humidity conditions, with boxplots. FIG. 13A illustrates the insertion force, FIG. 13B illustrates the maximum retention force and FIG. 13C illustrates the adhesion peak height.

FIGS. 14A to 14C illustrate the changes in characteristics of insertion and removal of connection terminals according to Sample 1 and Sample 2 after the Samples are under high-temperature and high-humidity conditions. FIG. 14A illustrates the insertion force, FIG. 14B illustrates the maximum retention force and FIG. 14C illustrates the adhesion peak height.

### DETAILED DESCRIPTION TO EXECUTE THE INVENTION

### Description of Embodiments of Disclosure

First, embodiments of the present disclosure are recited and described.

A first metal material according to the present disclosure includes a substrate and an Ag—Sn covering layer that covers a surface of the substrate, wherein the Ag—Sn covering layer contains Ag and Sn and has an Ag—Sn alloy exposed on a surface thereof, and an average crystal grain size in a cross section in parallel with a surface of the Ag—Sn covering layer is less than 0.28 μm.

The average crystal grain size in the Ag—Sn covering layer in the first metal material is suppressed to less than 0.28 μm. Such a small crystal grain size can be obtained according to progress of alloying and an enhancement in crystallinity during heating of a layer including Ag and Sn at a temperature equal to or more than the melting point of Sn. The Ag—Sn covering layer, after progress of alloying and the enhancement in crystallinity, is in the state where Ag is hardly sulfurized by reacting with the sulfur content in the air. Thus, the Ag—Sn covering layer is hardly blackened due to sulfurization even after a lapse of a long time and after heating. In addition, not only sulfurization, but also oxidation is suppressed.

A second metal material according to the present disclosure is produced by forming a metal layer including Ag and Sn, on a surface of a substrate, and heating the resultant at a temperature equal to or more than the melting point of Sn, and includes an Ag—Sn covering layer containing Ag and Sn and having an Ag—Sn alloy exposed on a surface thereof, on the surface of the substrate.

The second metal material is obtained by heating the metal layer including Ag and Sn at a temperature equal to or more than the melting point of Sn. Such heating at a temperature equal to or more than the melting point of Sn is conducted to result in not only sufficient progress of alloying between Ag and Sn in the metal layer including Ag and Sn, but also an enhancement in crystallinity of an Ag—Sn alloy formed. Thus, the Ag—Sn covering layer is in the state where Ag is hardly sulfurized by reacting with the sulfur content in the air. As a result, the Ag—Sn layer is hardly blackened due to sulfurization even after a lapse of a long time and after heating. In addition, not only sulfurization, but also oxidation is suppressed.

In the first metal material and the second metal material, the maximum crystal grain size in a cross section in parallel with a surface of the Ag—Sn covering layer may be 0.8 μm or less. Formation of the Ag—Sn covering layer as an aggregate of crystal grains low in grain size provides an indication of an enhancement in crystallinity in the layer. The Ag—Sn layer is enhanced in crystallinity until the maximum crystal grain size reaches 0.8 μm or less, and thus surface sulfurization can be effectively suppressed.

The frequency value of a deviation angle from an orientation accounting for the largest proportion in a crystal grain orientation in the cross section in parallel with a surface of the Ag—Sn covering layer may be 2.5% or less in the entire region of the deviation angle. A highly uniform distribution of the deviation angle from the most frequent orientation in a wide angle range means a small residual stress and a high crystallinity in the Ag—Sn covering layer, and provides a good indication of a state where the Ag—Sn covering layer is hardly sulfurized.

A region in which the Ag—Sn covering layer is formed, and a region in which the Ag—Sn covering layer is not formed and a Sn covering layer constituted as a Sn layer or a Sn alloy layer containing Ag only as an unavoidable impurity covers the surface of the substrate may be formed at different positions on the surface of the substrate. Thus, characteristics possessed in the Ag—Sn covering layer and characteristics possessed in the Sn covering layer can be each utilized in different regions of a common metal material. The Ag—Sn covering layer of the metal material according to the present disclosure can be suitably produced by heating a layer including Ag and Sn at a temperature equal to or more than the melting point of Sn, and the Sn covering layer and the layer including Ag and Sn can be allowed to coexist on the same substrate and then heated at a temperature equal to or more than the melting point of Sn and therefore a reflow treatment of the Sn covering layer can be performed at the same time as a formation and treatment of sulfurization suppression of the Ag—Sn covering layer.

The Ag—Sn covering layer may have a surface hardness of 180 Hv or more and 240 Hv or less. While the Ag—Sn covering layer of the metal material according to the present disclosure can be suitably produced by heating a layer including Ag and Sn at a temperature equal to or more than the melting point of Sn, the Ag—Sn covering layer can be lowered in degree of hardness by heating. However, a degree of hardness of 180 Hv or more can be kept to thereby allow the Ag—Sn covering layer to retain sufficient material strength and also sufficiently exhibit characteristics of an Ag—Sn alloy, such as a reduction in friction.

The Ag—Sn covering layer may have an oxygen concentration of 20% by atom or less at a position of a depth of 20 nm from the surface thereof when left in an environment at a temperature of 85° C. and a humidity of 85% RH for 480 hours. The Ag—Sn covering layer experiences progress in alloying and is enhanced in crystallinity, and thus hardly experiences progress in oxidation even under a high-temperature condition and can have an oxygen concentration at a position of a depth of 20 nm, suppressed at a level of 20% by atom or less, even after left in the environment. Oxidation hardly progresses and thus characteristics of an Ag—Sn alloy, such as a reduction in friction, are kept over a long period. Oxidation which hardly progresses indicates that sulfurization also hardly progresses.

The Ag—Sn covering layer may have no Ag grain formed on a surface thereof when left in an environment at a temperature of 85° C. and a humidity of 85% RH for 480 hours. A layer including an Ag—Sn alloy, if not sufficiently experience progresses in alloying and enhancement in crystallinity, easily has an Ag grain formed on a surface of the layer when placed in a high-temperature environment, but in this regard, the Ag—Sn covering layer of the metal material according to the present disclosure sufficiently experiences progress in alloying and is enhanced in crystallinity, and thus hardly has an Ag grain generated even when placed under a high-temperature condition. Accordingly, the Ag—Sn covering layer can maintain characteristics thereof over a long period.

The substrate may be constituted from Cu or a Cu alloy, and the metal material may further have an intermediate layer constituted from Ni or a Ni alloy between the substrate and the Ag—Sn covering layer. The metal material, which has a Cu or a Cu alloy as the substrate, can be suitably used as a constituent material of an electric connection member such as a connection terminal. An intermediate layer of Ni or a Ni alloy can be formed between the Ag—Sn covering layer and the substrate, to thereby suppress a Cu atom of the substrate from being diffused into the Ag—Sn covering layer from the substrate and having an influence on characteristics of the Ag—Sn covering layer, such as electric connection characteristics, under a high-temperature environment.

A region in which the Ag—Sn covering layer is formed, and a region in which the Ag—Sn covering layer is not formed and a Sn covering layer constituted as a Sn layer or a Sn alloy layer containing Ag only as an unavoidable impurity covers the surface of the substrate may be formed on a continuous common surface of the intermediate layer, at different positions on the surface of the substrate. The Sn covering layer is often used as a surface covering layer of an electric connection member, and the Ag—Sn covering layer and the Sn covering layer are disposed on a surface of a common substrate constituted from Cu or a Cu alloy and thus both characteristics respectively possessed in the layers can be utilized at different places of an electric connection member such as a connection terminal. The intermediate layer constituted from Ni or a Ni alloy has an effect of suppression of diffusion of a Cu atom from the substrate, on the Ag—Sn covering layer and also on the Sn covering layer.

The metal material may further have an Ag strike layer between the Ag—Sn covering layer and the intermediate layer. Thus, adhesiveness of the Ag—Sn covering layer to the substrate and the intermediate layer can be enhanced. The presence of the strike layer has almost no influence on characteristics of the Ag—Sn covering layer, such as the degree of hardness.

A connection terminal according to the present disclosure is constituted from the metal material, wherein the Ag—Sn covering layer is formed on the surface of the substrate, at least in a contact portion to be in electric contact with a counter conductive member.

The connection terminal has the Ag—Sn covering layer on a surface of the contact portion. The Ag—Sn covering layer experiences progress in alloying and is enhanced in crystallinity and thus hardly experiences progress in sulfurization, and therefore is hardly transubstantiated, for example, surface blackened and oxidized due to sulfurization, even if the connection terminal is stored or used in a high-temperature environment over a long time. The connection terminal is hardly changed significantly also in characteristics such as a behavior in sliding thereof against a counter conductive member.

Herein, the connection terminal may be formed in an elongated manner, the connection terminal may have a first contact portion including the Ag—Sn covering layer, at one end in a longitudinal direction thereof, and the connection terminal may have a second contact portion including the Sn covering layer constituted as a Sn layer or a Sn alloy layer containing Ag only as an unavoidable impurity, at the other end in the longitudinal direction thereof. The connection terminal, which has the first contact portion and the second contact portion at both ends, can be suitably used in an application where two different conductive members are electrically connected. Here, the Ag—Sn covering layer is disposed on the first contact portion and the Sn covering layer is disposed on the second contact portion, and characteristics of the respective covering layers can be utilized for connection to respective counter conductive members. In a connection terminal production process, a connection terminal having an Ag—Sn covering layer suppressed in sulfurization and a Sn covering layer suppressed in generation of whiskers by a reflow treatment can be obtained by heating the entire material constituting the connection terminal to a temperature equal to or more than the melting point of tin in the state where the layer including Ag and Sn is disposed at a position serving as the first contact portion and the Sn covering layer is disposed at a position serving as the second contact portion.

The connection terminal may be formed as a press-fit terminal, and the connection terminal may have the Ag—Sn covering layer at a place where the press-fit terminal, when inserted into a through-hole, is contacted with an inner periphery of the through-hole. Thus, characteristics possessed in the Ag—Sn covering layer, such as a low friction coefficient and a high heat resistance, can be suitably utilized for connection between the press-fit terminal and the through-hole.

In this case, the insertion force in insertion of the connection terminal into the through-hole having a Sn layer in the inner periphery may be suppressed to 20% or less in terms of amount of change after the connection terminal is left in the atmosphere at 50° C. over 155 days, relative to the value in the initial state. Moreover, the maximum retention force in removal of the connection terminal inserted into the through-hole having a Sn layer in the inner periphery may be suppressed to 20% or less in terms of amount of change after the connection terminal is left in the atmosphere at 50° C. over 155 days, relative to the value in the initial state. Furthermore, the adhesion peak height in removal of the connection terminal inserted into the through-hole having a Sn layer in the inner periphery may be suppressed to 35% or less in terms of amount of change after the connection terminal is left in the atmosphere at 50° C. over 155 days, relative to the value in the initial state. The Ag—Sn covering layer disposed on a surface of the connection terminal formed as the press-fit terminal experiences progress in alloying and an enhancement in crystallinity and thus is stabilized, and correspondingly is suppressed in changes in characteristics, caused in insertion and removal thereof into and from the through-hole, at low levels as described above even after placed in a high-temperature environment. As a result, characteristics of the press-fit terminal can be highly maintained even after long-term storage and use.

A method for producing a metal material according to the present disclosure is to produce the above metal material by forming a metal layer including Ag and Sn, on a surface of a substrate, and thereafter heating the resultant at a temperature equal to or more than the melting point of Sn.

In the method for producing the metal material, the layer including Ag and Sn is formed and then heated to a temperature equal to or more than the melting point of Sn. Such heating results in not only sufficient progress of alloying, but also an enhancement in crystallinity in the layer. As a result, a metal material can be suitably produced which includes a layer of an Ag—Sn alloy hardly undergoing sulfurization due to the sulfur content in the air.

Here, not only a metal layer including Ag and Sn may be formed in a first region as a partial region of the surface of the substrate, but also a Sn layer or a Sn alloy layer containing Ag only as an unavoidable impurity may be formed in a second region as a different region from the first region of the surface of the substrate, and thereafter both the first region and the second region may be heated to a temperature equal to or more than the melting point of Sn. A metal material in which an Ag—Sn covering layer and a Sn covering layer are formed in different regions on a common substrate is expected to be demanded as a material for a connection terminal, and such a metal material including two covering layers can be simply produced by forming a layer including Ag and Sn and a Sn layer or a Sn alloy layer in different regions of a substrate and heating the resultant to a temperature equal to or more than the melting point of Sn. Such heating to a temperature equal to or more than the melting point of Sn allows an Ag—Sn covering layer to experience progress in alloying and be enhanced in crystallinity and thus be hardly sulfurized, and allows a Sn covering layer to hardly have whiskers caused thereon by application of a reflow treatment.

### DETAILS OF EMBODIMENTS OF DISCLOSURE

Hereinafter, embodiments of the present disclosure will be described with reference to the drawings. The content (concentration) of each element is herein expressed by the ratio of the numbers of atoms, such as “% by atom”, unless particularly noted. Herein, a single metal also encompasses one containing any unavoidable impurity. Furthermore, an alloy containing a certain metal as a main component refers to an alloy in which 50% by atom or more of such a metal element is contained in a composition. The term “cross section”, when simply mentioned herein, refers to a cross section perpendicular to a surface of a metal material, or is otherwise specified if refers to a cross section in parallel with a surface.

<Outline of Metal Material and Connection Terminal>

First, a metal material and a connection terminal according to one embodiment of the present disclosure are simply described.

(Metal Material)

A metal material according to one embodiment of the present disclosure has a structure of a stacked metal material. The metal material according to one embodiment of the present disclosure may constitute any metal member, and can be suitably utilized as a material constituting an electric connection member such as a connection terminal.

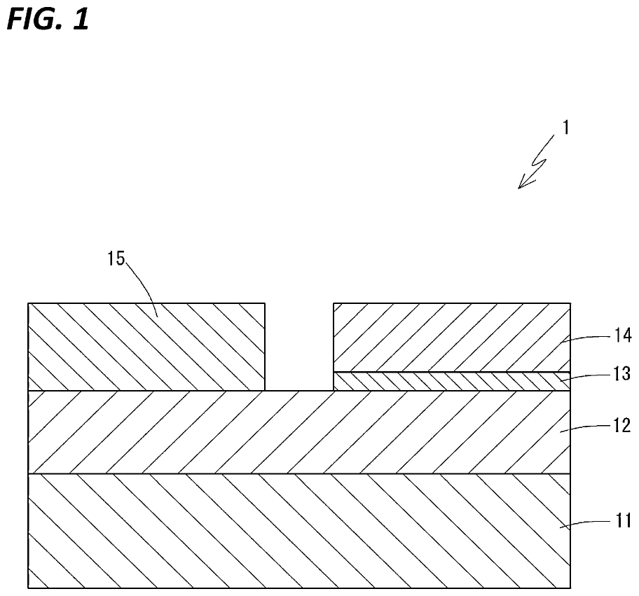

FIG. 1 illustrates a constitution example of a metal material 1 according to one embodiment of the present disclosure. The metal material 1 has a substrate 11 and an Ag—Sn covering layer 14 that covers a surface of the substrate 11 and that is exposed on the outermost surface. Furthermore, an intermediate layer 12 and an Ag strike layer 13 are preferably disposed between the substrate 11 and the Ag—Sn covering layer 14. The intermediate layer 12 is disposed with being in contact with a surface of the substrate 11, and the Ag strike layer 13 is disposed between the intermediate layer 12 and the Ag—Sn covering layer 14.

The substrate 11 can be constituted from a metal raw material having any shape such as a plate shape. The material constituting the substrate 11 is not particularly limited, but when the metal material 1 constitutes an electric connection member such as a connection terminal, Cu or a Cu alloy, Al or an Al alloy, Fe or a Fe alloy, or the like can be suitably used as the material constituting the substrate 11. In particular, Cu or a Cu alloy excellent in electric conductivity can be suitably used.

While the Ag—Sn covering layer 14 will be described below in detail, the Ag—Sn covering layer 14 is a metal layer containing Ag and Sn, and is preferably constituted as a metal layer containing only Ag and Sn, except for unavoidable impurities. The Ag—Sn covering layer 14 contains an Ag—Sn alloy, and the Ag—Sn alloy is exposed at least on the outermost surface of the Ag—Sn covering layer 14. A specific composition of the Ag—Sn alloy constituting the Ag—Sn covering layer 14 is not particularly limited, but an intermetallic compound having a composition of Ag₃Sn is preferably formed from the viewpoints of stability and ease of formation of the alloy. Most of Ag atoms and Sn atoms constituting the Ag—Sn covering layer 14, preferably the entire thereof except for unavoidable impurities preferably constitute the Ag—Sn alloy, in particular, an Ag₃Sn alloy, from the viewpoint that progress of alloying and an enhancement in crystallinity, as described below, are sufficiently achieved. Herein, Ag and/or Sn not sufficiently alloyed may remain with occupying a part of a region downside of the Ag—Sn covering layer 14 (facing the substrate 11).

The thickness of the Ag—Sn covering layer 14 is not particularly limited, but is preferably 0.10 μm or more, further preferably 0.25 μm or more from the viewpoint that, for example, characteristics of the Ag—Sn alloy, such as a reduction in surface friction, are sufficiently exhibited. On the other hand, the thickness of the Ag—Sn covering layer 14 is preferably 3.0 μm or less, further preferably 1.0 μm or less from the viewpoint that, for example, an increase in material cost due to formation of an excessively thick Ag—Sn covering layer 14 is avoided.

The intermediate layer 12 functions to enhance adhesiveness between the substrate 11 and the Ag—Sn covering layer 14, and/or functions to suppress constituent elements from being mutually diffused between the substrate 11 and the Ag—Sn covering layer 14. Examples of the material constituting the intermediate layer 12 can include a metal raw material containing at least any one selected from the group consisting of Ni, Cr, Mn, Fe, Co, and Cu. The material constituting the intermediate layer 12 may be a single metal as one selected from the above group or may be an alloy containing one or more metal elements selected from the above group. When the substrate 11 is constituted from Cu or a Cu alloy, the intermediate layer 12 is preferably constituted particularly from Ni or an alloy containing Ni as a main component. In this case, the intermediate layer 12 can effectively suppress Cu atoms of the substrate 11 from being diffused into the Ag—Sn covering layer 14. The thickness of the intermediate layer 12 is not particularly limited, and can be suitably, for example, 1.0 μm or more and 5.0 μm or less.

The Ag strike layer 13 is a thin layer constituted from Ag or an alloy (except for an Ag—Sn alloy) containing Ag as a main component. The Ag strike layer 13 functions to enhance adhesiveness of the Ag—Sn covering layer 14 to the substrate 11 and the intermediate layer 12. The thickness of the Ag strike layer 13 is also not particularly limited, and can be suitably, for example, 0.01 μm or more and 0.1 μm or less.

In the metal material 1, an alloy may be formed by ingredient elements of both layers at an interface with respect to each layer stacked or in the vicinity of such each layer, as long as characteristics of such each layer are not significantly impaired. A thin film (not illustrated) such as an organic layer may also be disposed on the Ag—Sn covering layer 14 exposed on the outermost surface of the metal material 1, as long as characteristics of the Ag—Sn covering layer 14 are not impaired.

In the metal material 1 according to the present embodiment, the Ag—Sn covering layer 14 (and the intermediate layer 12 and the Ag strike layer 13) may cover the entire region of a surface of the substrate 11, or may cover only a partial region of the surface of the substrate 11. When the Ag—Sn covering layer 14 occupies only a partial region of the surface of the substrate 11, a metal layer different from the Ag—Sn covering layer 14 may be formed on a part or the entire of a region not occupied by the Ag—Sn covering layer 14. Thus, characteristics of the Ag—Sn covering layer 14 and characteristics of any other metal layer can be utilized in different regions of the surface of the substrate 11 in the metal material 1.

Suitable examples of a mode where the Ag—Sn covering layer 14 and any other metal layer coexist on the surface of the common substrate 11 can include a mode where a region in which the Ag—Sn covering layer 14 is formed and a region in which no Ag—Sn covering layer 14 is formed and a Sn covering layer 15 is formed coexist with occupying positions different from each other on the surface of the substrate 11. The Sn covering layer 15 is constituted as a Sn layer made of only Sn except for unavoidable impurities, or as a layer of a Sn alloy containing Ag as only an unavoidable impurity (containing Ag in an amount less than an amount that enables such Ag to be regarded as an unavoidable impurity). When the Ag—Sn covering layer 14 and the Sn covering layer 15 thus coexist, the intermediate layer 12 of Ni or a Ni alloy is formed as a continuous metal layer on the surface of the substrate 11, as illustrated in FIG. 1, and a mode is preferable where the Ag—Sn covering layer 14 (and the Ag strike layer 13) and the Sn covering layer 15 are formed with occupying different regions on a surface of the common intermediate layer 12.

(Connection Terminal)

Next, a connection terminal according to one embodiment of the present disclosure is described. The connection terminal according to one embodiment of the present disclosure is constituted by use of the metal material 1 according to the embodiment, and has the Ag—Sn covering layer 14 (and the intermediate layer 12 and the Ag strike layer 13) at least on a surface of a contact portion to be in electric contact with a counter conductive member.

As long as the Ag—Sn covering layer 14 is formed at least on such a contact portion on a surface of the connection terminal, the Ag—Sn covering layer 14 may cover the entire surface of the connection terminal or may cover only a partial region thereof. Preferably, the connection terminal may have a plurality of such contact portions, and the Ag—Sn covering layer 14 may be formed on a surface of at least one of such contact portions and other metal layer may be formed on surfaces of other of such contact portions. For example, a mode is suitable where the connection terminal is formed in an elongated manner and has a first contact portion including the Ag—Sn covering layer 14 and a second contact portion where the Sn covering layer 15 is formed, respectively, at one end and other end in a longitudinal direction thereof.

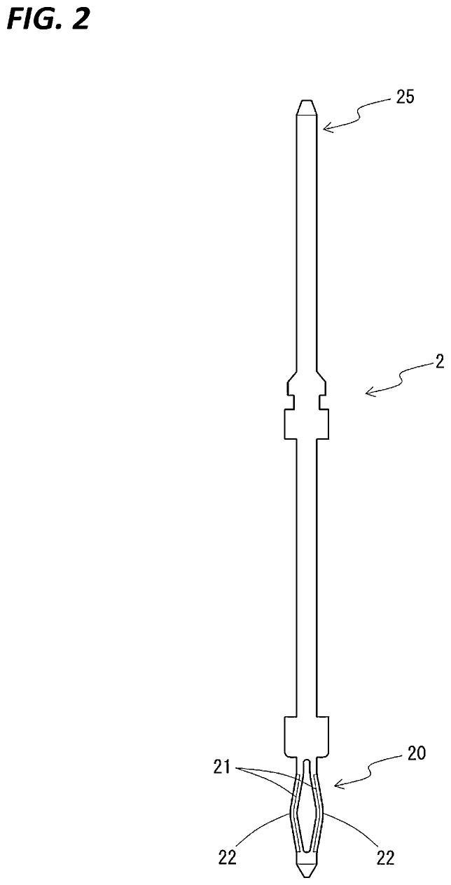

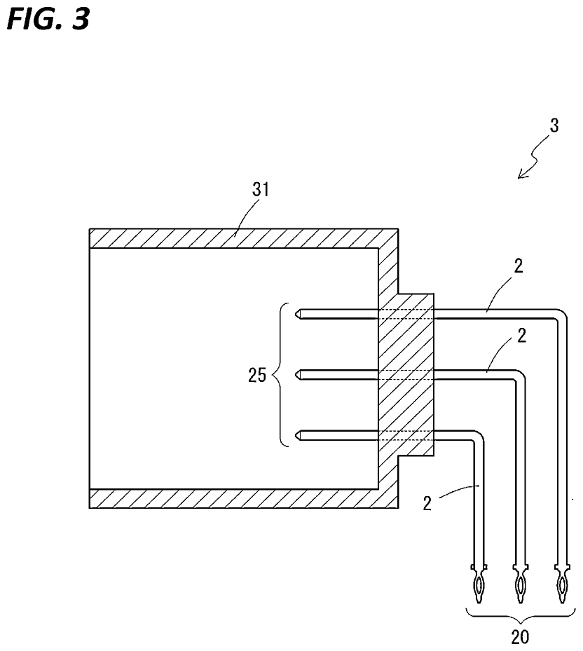

Specific type and shape of the connection terminal are not particularly limited, and suitable examples can include a case of a press-fit terminal 2 as illustrated in FIGS. 2 and 3. The press-fit terminal 2 is an elongated electric connection terminal, and has a board connection portion 20 to be injected and connected to a through-hole of a printed circuit board, at one end, and a terminal connection portion 25 to be connected to a counter connection terminal by fitting or the like, at the other end. In an example illustrated, the terminal connection portion 25 has a shape of a male-type fitting terminal.

The board connection portion 20 has a pair of swollen pieces 21 and 21 on a portion to be injected and connected to the through-hole. The swollen pieces 21 and 21 have a substantially arc-like swollen shape so as to be apart from each other in a direction perpendicular to an axial line direction (lengthwise direction in FIG. 2) of the press-fit terminal 2. If a top protruding outermost on outer surfaces of the swollen pieces 21 and 21 in a swollen direction is injected into the through-hole, the pieces serve as contact portions 22 and 22 to be contacted with an inner periphery of the through-hole.

The press-fit terminal 2 can be suitably used as a connector 3 for a board (PCB connector), as illustrated in FIG. 3. In the connector 3 for a board, a plurality of the press-fit terminals 2 are placed alongside and secured to a connector housing 31 made of a resin material. The press-fit terminal 2 may be appropriately bent at a site between the board connection portion 20 and the terminal connection portion 25.

In the press-fit terminal 2, the contact portions 22 and 22 of the swollen pieces 21 and 21 in the board connection portion 20 each correspond to the first contact portion, and the Ag—Sn covering layer 14 is formed on a surface of the board connection portion 20 including the contact portions 22 and 22. On the other hand, a surface of a male-type fitting terminal constituting the terminal connection portion 25 corresponds to the second contact portion, and the Sn covering layer 15 is constituted on a surface of the terminal connection portion 25. The Ag—Sn covering layer 14 is preferably formed on the board connection portion 20 to be injected and connected to the through-hole and the Sn covering layer 15 is preferably formed on the terminal connection portion 25 to be fitted and connected to a female-type fitting terminal, from the viewpoint of a reduction in insertion force between each portion of the board connection portion 20 and the terminal connection portion 25, and a counter member.

<Method for Producing Metal Material>

A method for producing the metal material 1 is here described. The Ag—Sn covering layer 14 in the metal material 1 can be formed by forming an Ag—Sn precursor layer including both Ag and Sn, and then performing heating at a temperature equal to or more than the melting point (232° C.) of Sn.

Specifically, first, the intermediate layer 12 and the Ag strike layer 13 are appropriately formed on a surface of the substrate 11 by a plating method or the like, and then the Ag—Sn precursor layer including both Ag and Sn is formed. The Ag—Sn precursor layer can be formed by forming a metal layer including Ag and Sn and then appropriately alloying Ag and Sn. The metal layer including Ag and Sn may be a single layer including both Ag and Sn or a stacked article including a layer including Ag and a layer including Sn. The single layer including both Ag and Sn can be formed by, for example, co-precipitation with a plating solution including both Ag and Sn. In this case, the contents of Ag and Sn in the plating solution may be appropriately determined based on a desired alloy composition in the Ag—Sn covering layer 14 to be formed. On the other hand, such a structure where the layer including Ag and the layer including Sn are stacked can be produced by sequentially forming such Ag layer and Sn layer by a plating method or the like. In this case, the order of stacking and the number of stacked layers of the Ag layer and the Sn layer are not particularly limited, and a suitable example can be a mode where one of the Sn layer is formed and then one of the Ag layer is formed thereon. The thicknesses of the Sn layer and the Ag layer may be appropriately determined based on desired alloy composition and thickness of the Ag—Sn covering layer 14 to be formed.

At least part of Ag and Sn are often progressively alloyed in the metal layer including Ag and Sn in the single layer or a plurality of such layers mutually stacked, even without any special treatment such as heating. In particular, when Ag and Sn coexist in the single layer, alloying thereof easily progresses. Accordingly, the metal layer including Ag and Sn formed as the single layer or a stacking structure of a plurality of such layers may be adopted as the Ag—Sn precursor layer as it is, or one obtained by heating the metal layer for progress of alloying of Ag and Sn may be appropriately adopted as the Ag—Sn precursor layer. Herein, Ag and Sn in the Ag—Sn precursor layer may be alloyed not completely even if the layer is heated. Accordingly, it is sufficient that the metal layer including Ag and Sn formed as the single layer or the stacking structure of a plurality of such layers, as described above, are heated at a temperature less than the melting point of Sn and thus experience progress in alloying. The heating temperature in alloying can be, for example, a temperature of 180° C. or more and 230° C. or less.

Once a precursor layer including Ag and Sn is formed, the metal material 1 where the precursor layer is formed is heated to a temperature equal to or more than the melting point of Sn, to thereby form the Ag—Sn covering layer 14. The heating not only leads to further progress of alloying of Ag and Sn from the state of the precursor layer, but also leads to an enhancement in crystallinity of an Ag—S alloy in the layer. The change in state in the layer due to the heating will be described below in detail. The temperature in the heating of the precursor layer is not particularly limited as long as it is equal to or more than the melting point of Sn, but is preferably 300° C. or more from the viewpoint that the effects of promotion of alloying and an enhancing in crystallinity are sufficiently obtained. In this regard, the temperature is preferably 400° C. or less from the viewpoint that the influence due to excess heating, such as softening of the Ag—Sn covering layer 14, is suppressed.

When the metal material 1 is produced where the Ag—Sn covering layer 14 and the Sn covering layer 15 coexist on different regions on a surface of the common substrate 11 as illustrated in FIG. 1, preferably, not only the Ag—Sn precursor layer including Ag and Sn is formed in a first region, but also a Sn precursor layer including Sn or an Sn alloy is formed in a second region different from the first region, and both the regions are simultaneously heated to a temperature equal to or more than the melting point of Sn. For example, first, the intermediate layer 12 of Ni or a Ni alloy is formed in the entire region of a surface of the substrate 11. The Ag strike layer 13 is appropriately formed in a region where the Ag—Sn covering layer 14 is to be formed, and then the Ag—Sn precursor layer is formed. The Ag—Sn precursor layer can be formed by forming the metal layer including Ag and Sn, as the single layer or the stacking structure of a plurality of such layers, as described above, and appropriately heating the resultant. On the other hand, a Sn precursor layer made of Sn or a Sn alloy containing Sn or Ag as only an unavoidable impurity is formed in a region where the Sn covering layer 15 is to be formed, by a plating method or the like. The formation of the Ag—Sn precursor layer and the formation of the Sn precursor layer may be performed in any order, and one of layers may be formed at a predetermined position on a surface of the substrate 11 and then other thereof may be formed at other predetermined position thereon.

After the Ag—Sn precursor layer and the Sn precursor layer are formed at separate positions on a surface of the substrate 11, the entire region of the substrate 11 is heated to a temperature equal to or more than the melting point of Sn. The heating provides the metal material 1 including the Ag—Sn covering layer 14 and the Sn covering layer 15. The Ag—Sn precursor layer is heated to a temperature equal to or more than the melting point of Sn, as described above, and thus progress of alloying and an enhancement in crystallinity occur. On the other hand, an operation for heating the Sn precursor layer to a temperature equal to or more than the melting point of Sn is generally conducted as a reflow treatment, and has effects of surface smoothing and of suppression of generation of whiskers due to a reduction in residual stress. The entire region of the metal material 1 can be thus subjected to reflow heating corresponding to heating to a temperature equal to or more than the melting point of Sn, at one time, and thus characteristics of both the Ag—Sn covering layer 14 and the Sn covering layer 15 can be improved. A heating procedure is not particularly limited, and heating by hot air or induction heating can be suitably applied.

The metal material 1 obtained after the reflow heating are appropriately subjected to machining such as punching or bending, and thus various metal members such as a connection terminal can be produced. Herein, the reflow heating may be performed after the machining.

<State of Ag—Sn Covering Layer and Characteristics of Metal Material>

Next, there are described the state of the Ag—Sn covering layer 14 in the metal material 1 according to the present embodiment and characteristics of the metal material 1.

The Ag—Sn covering layer 14 is a layer including Ag and Sn and having an Ag—Sn alloy exposed on the outermost surface thereof, as described above, and can be suitably formed by heating the Ag—Sn precursor layer to a temperature equal to or more than the melting point of Sn (reflow heating). The Ag—Sn covering layer 14, after reflow heating, thus not only experiences progress in alloying, but also is enhanced in crystallinity, as compared with the Ag—Sn precursor layer before reflow heating.

The Ag—Sn covering layer 14 experiences progress in alloying as compared with the Ag—Sn precursor layer before reflow heating, and thus contains less Ag and/or Sn not forming any alloy, but remaining. If an Ag—Sn alloy relatively low in stability is formed in the Ag—Sn precursor layer, an alloy higher in stability, such as an Ag₃Sn alloy, is then formed. Typically, while many granules considered to be formed from Sn not alloyed completely with Ag are present in a surface of the Ag—Sn precursor layer, such granules are remarkably decreased in a surface of the Ag—Sn covering layer 14 heated, and a smooth surface is obtained. For example, the density of such granules in the surface of the Ag—Sn covering layer 14 can be 1/μm² or less, further 0.5/μm² or less.

The crystal grain size of the crystal grain contained in the Ag—Sn covering layer 14 is decreased by heating, as compared with that in the Ag—Sn precursor layer. Typically, the crystal grain size (equivalent area diameter; the same applies to the following) in a cross section in parallel with a surface of the Ag—Sn covering layer 14 is less than 0.28 μm in terms of average grain size. The average grain size may be more preferably 0.27 μm or less, further preferably 0.25 μm or less. The maximum value of the crystal grain size in the cross section in parallel with the surface may be 1.1 μm or less, further 1.0 μm or less, or 0.8 μm or less. The crystal grain size in the Ag—Sn covering layer 14 can be evaluated based on an image observed with a scanning electron microscope (SEM) or a crystal grain distribution image according to an electron beam backscatter diffraction method (EBSD).

A decrease in crystal grain size in the Ag—Sn covering layer 14, after reflow heating, is considered to be due to an enhancement in crystallinity by heating. An enhancement in crystallinity allows for a reduction in residual stress in the Ag—Sn covering layer 14, and accordingly a decrease in strain at a crystal grain boundary. Thus, recrystallization and grain boundary rearrangement occur, and a crystal grain lower in grain size than that before reflow heating is formed. An enhancement in crystallinity allows for a grain boundary strain kept small, as a whole, even in the state of a low crystal grain size and a high density at the grain boundary.

A reduction in residual stress in the Ag—Sn covering layer 14 is observed also in a crystal grain orientation distribution. A decrease in strain at the grain boundary along with a reduction in residual stress allows, for example, the frequency value of a deviation angle from a specified orientation (accounting for the largest proportion orientation among all orientations) in a crystal grain orientation distribution evaluated by EBSD not to be concentrated at a specified deviation angle, but to be highly uniformly distributed in a wide angle range. The frequency value of a deviation angle from the specified orientation in a cross section in parallel with a surface of the Ag—Sn covering layer 14 is typically 2.5% or less, furthermore 2.2% or less in the entire region of the deviation angle.

The Ag—Sn covering layer 14 is occupied by a crystal grain of a stable Ag—Sn alloy in the layer, due to progress of alloying and an enhancement in crystallinity, and as a result, is increased in chemical stability. In other words, Ag atoms and Sn atoms constituting the Ag—Sn covering layer 14 hardly react chemically with other substances. In particular, the Ag—Sn covering layer 14 is hardly sulfurized by a sulfur molecule contained in the atmosphere and oxidized by an oxygen molecule contained therein, and also changed in distribution of Ag atoms and Sn atoms.

Ag is a metal to be easily bound to S, and a sulfide may also be formed by an Ag atom contained in a layer including an Ag—Sn alloy. As shown in Examples below, an Ag—Sn precursor layer after no reflow heating, when actually located in a high-temperature environment or left for a long time, is sulfurized to lead to blackening of a surface thereof. However, the Ag—Sn covering layer 14 after reflow heating is hardly sulfurized and is remarkably suppressed in surface blackening after undergoing a high-temperature environment or after a lapse of a long time. While sulfurization at a level of blackening the surface slightly has a remarkable influence on characteristics of the Ag—Sn covering layer 14, blackening may cause users or the like to have suspicions about the influence on characteristics, and suppression thereof is preferred.

While the layer including an Ag—Sn alloy, if oxidized, results in mainly binding of a Sn atom to not an Ag atom, but an O atom, the Ag—Sn covering layer 14 after reflow heating is hardly thus oxidized as compared with an Ag—Sn precursor layer after no reflow heating. While even the Ag—Sn covering layer 14 after reflow heating, when left in a high-temperature and high-humidity atmosphere for a long time, is oxidized to a certain extent, penetration of an O atom into a covering layer, due to oxidation, remains in a relatively shallow range. In other words, the thickness of a film oxidized is hardly increased.

For example, as shown in Examples below, the Ag—Sn covering layer 14, even after a lapse of 24 hours in the air at a temperature of 85° C. and a humidity of 85% RH (hereinafter, referred to as “high-temperature and high-humidity conditions”), is almost not changed in depth distribution of O atoms, and the amount of increase in O atom concentration at a position of a depth of 20 nm from the outermost surface is suppressed to 10% or less, further 5% or less, relative to that in the initial state. Further preferably, the concentration value of an O atom at a position of a depth of 20 nm from the outermost surface is suppressed to be equal to or less than the detection limit of depth analysis X-ray photoelectron spectroscopy (XPS), in the initial state and in a state after a lapse of 24 hours under high-temperature and high-humidity conditions. Furthermore, although oxidation more progresses after a lapse of 480 hours under high-temperature and high-humidity conditions, than after a lapse of 24 hours under the conditions, the concentration value of an O atom at a position of a depth of 20 nm from the outermost surface of the Ag—Sn covering layer 14 is suppressed to 20% by atom or less, further 10% by atom or less. Herein, degradation after a lapse of 24 hours under high-temperature and high-humidity conditions of a temperature of 85° C. and a humidity of 85% RH can correspond to degradation in the case of being left in the atmosphere at room temperature for half a year. In other words, suppression of progress of oxidation of the Ag—Sn covering layer 14 at a low level even after a lapse of 24 hours, further 480 hours under high-temperature and high-humidity conditions means that the Ag—Sn covering layer 14 is maintained without being largely affected by oxidation even after storage for a long-term, such as for half a year or for ten years, in the atmosphere.

Furthermore, the Ag—Sn covering layer 14, after reflow heating, experiences progresses in alloy formation and enhancement in crystallinity, and thus is stably maintained in a state where a crystal grain of an Ag—Sn alloy typified by Ag₃Sn is formed, and the concentration distribution of an Ag atom and a Sn atom in the layer is hardly changed due to a lapse of time. For example, the amount of change in Ag atom concentration at a position of a depth of 20 nm from the outermost surface of the Ag—Sn covering layer 14 after a lapse of 24 hours under high-temperature and high-humidity conditions is suppressed to 10% or less, further 5% or less, relative to that in the initial state. Furthermore, the amount of change in Ag atom concentration oat a position of a depth of 20 nm from the outermost surface of the Ag—Sn covering layer 14 after a lapse of 480 hours under high-temperature and high-humidity conditions is suppressed to 30% or less, further 25% or less, relative to that in the initial state.

The Ag—Sn covering layer 14 allows a precipitate biased in alloy composition to be hardly generated due to stability of an Ag—Sn alloy even after left in a high-temperature environment or even after left for a long time. For example, if an Ag—Sn precursor layer after no reflow heating is left under high-temperature and high-humidity conditions for 480 hours, a granulated substance (Ag grain) corresponding to a pure Ag metal is precipitated on the surface. On the other hand, even if the Ag—Sn covering layer 14 after reflow heating is left under high-temperature and high-humidity conditions for 480 hours, neither an Ag grain, nor a granular precipitate that can be observed with SEM is generated on the surface.

As above, the Ag—Sn covering layer 14, after reflow heating, not only experiences progress in alloying, but also is enhanced in crystallinity, and correspondingly is in the texture of an aggregate of a small crystal grain, reduced in residual stress, and is in the state of being enhanced in chemical stability. As a result, the Ag—Sn covering layer 14, even after left for a long time, is hardly blackened due to sulfurization and oxidized, changed in metal atom distribution, and the like, and can stably maintain characteristics of an Ag—Sn alloy over a long period.

Herein, the Ag—Sn covering layer 14 is observed to be slightly lowered in mechanical strength due to reflow heating. For example, while a surface of an Ag—Sn precursor layer after no reflow heating can exhibit a high degree of hardness of more than 240 Hv, the Ag—Sn covering layer 14 after reflow heating often exhibits a degree of hardness of 240 Hv or less. However, the degree of reduction in degree of hardness can be kept low, and a degree of hardness of 180 Hv or more, further 200 Hv or more can be kept even in the Ag—Sn covering layer 14 after heating. Such a degree of hardness is sufficiently high as the degree of hardness to be possessed in an electric connection member to be slid on a surface, such as a connection terminal. The Ag—Sn covering layer 14 is thus kept low in reduction in degree of hardness, and thus high characteristics can be exhibited in a connection terminal having the Ag—Sn covering layer 14, as described below.

<Characteristics of Connection Terminal>

Finally, characteristics of a connection terminal having the Ag—Sn covering layer 14, in insertion and removal into and from a through-hole, are described with respect to characteristics of the press-fit terminal 2 where the Ag—Sn covering layer 14 is formed on a surface of the board connection portion 20 as illustrated in FIGS. 2 and 3.

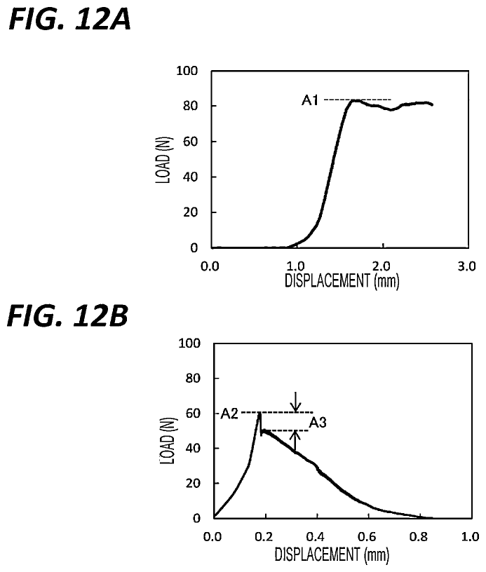

As described above, the Ag—Sn covering layer 14, even after reflow heating, maintains mechanical strength, for example, the degree of hardness at a high level, and correspondingly, a behavior associated with a friction phenomenon in insertion and removal of the press-fit terminal 2 is maintained in a favorable state. For example, the insertion force (A1 in FIG. 12A; the maximum value of the load in insertion) in insertion of the board connection portion 20 of the press-fit terminal 2 into a through-hole (having a Sn layer on an inner periphery; the same applies to the following), with respect to the Ag—Sn covering layer 14 after reflow heating, is suppressed to an amount of increase of 5% or less, relative to the value with respect to the Ag—Sn precursor layer before reflow heating. Furthermore, a state can be maintained where no insertion force is increased even after reflow heating. No scraping (wear) occurs in a surface of the Ag—Sn covering layer 14 in terminal insertion. The insertion force is an amount having a positive correlation with the kinetic friction coefficient in terminal insertion, and a smaller insertion force is more preferable because the force necessary for insertion of the press-fit terminal 2 is kept small.

The maximum retention force (A2 in FIG. 12B; maximum value of load in removal) in removal of the board connection portion 20 of the press-fit terminal 2 from a through-hole, with respect to the Ag—Sn covering layer 14 after reflow heating, is not decreased relative to the value with respect to the Ag—Sn precursor layer before reflow heating, and can be further an amount of increase of 3% or more. The maximum retention force is an amount having a positive correlation with a static friction coefficient in terminal removal, and a larger maximum retention force is more preferable because a state of the press-fit terminal 2 injected and connected to a through-hole is stably retained. No decrease and furthermore an increase in maximum retention force with respect to the Ag—Sn covering layer 14 after reflow heating are suitable in terms of stable retention of an electric connection state.

Furthermore, the adhesion peak height (A3 in FIG. 12B; corresponding to the load peak height in removal, and also the difference in load between the peak top and a subsequent flat zone) in removal of the board connection portion 20 of the press-fit terminal 2 from a through-hole, with respect to the Ag—Sn covering layer 14 after reflow heating, is not decreased relative to the value with respect to the Ag—Sn precursor layer before reflow heating, and can be further an amount of increase of 5% or more. The adhesion peak height is an amount having a positive correlation with the difference between the static friction coefficient and the kinetic friction coefficient in terminal removal, and a higher adhesion peak height is more preferable because, while stability of a state of the press-fit terminal 2 injected and connected to a through-hole is increased, the force necessary for removal can be smaller. An increase in adhesion peak height with respect to the Ag—Sn covering layer 14 after reflow heating is suitable in that both stable retention of an electric connection state and a reduction in force necessary for removal are achieved.

As described above, the Ag—Sn covering layer 14 formed in the board connection portion 20 of the press-fit terminal 2, after reflow heating, not only has a certain low insertion force, but also has high maximum retention force and adhesion peak height, and effectively exhibits the characteristics of allowing for a reduction in force necessary for insertion and removal and stable retention of a terminal injection state, exhibited by an Ag—Sn alloy. Furthermore, the Ag—Sn covering layer 14 achieves high chemical stability due to progress of alloying and an enhancement in crystallinity, and thus characteristics thereof can be maintained at high levels even if the press-fit terminal 2 is left for a long time or left in a high-temperature environment.

Specifically, the press-fit terminal 2 including the Ag—Sn covering layer 14, after reflow heating, in the board connection portion 20 can suppress an amount of change (mainly, amount of increase) in insertion force after left in the atmosphere in an environment at 50° C. (hereinafter, sometimes referred to as “medium temperature conditions”) for 155 days, to 20% or less, further 10% or less, relative to that in the initial state. The terminal can also suppress an amount of change (mainly, amount of increase) after left under high-temperature and high-humidity conditions for 480 hours, to 20% or less, further 10% or less, relative to that in the initial state.

The amount of change (amount of increase or amount of decrease) in maximum retention force after a lapse of 155 days under medium temperature conditions, in the Ag—Sn covering layer 14 after reflow heating, can be suppressed to 20% or less, further 10% or less, relative to that in the initial state. The amount of change (amount of increase or amount of decrease) after a lapse of 480 hours under high-temperature and high-humidity conditions can also be suppressed to 20% or less, further 10% or less, relative to that in the initial state.

The amount of change (mainly, amount of decrease) in adhesion peak height after a lapse of 155 days under medium temperature conditions, in the Ag—Sn covering layer 14 after reflow heating, can be suppressed to 35% or less relative to that in the initial state. The amount of change (mainly, amount of decrease) after a lapse of 480 hours under high-temperature and high-humidity conditions can also be suppressed to 35% or less, further 10% or less, relative to that in the initial state.

Thus, the board connection portion 20 of the press-fit terminal 2 including the Ag—Sn covering layer 14, even after left in a heating environment, furthermore a high-temperature and high-humidity environment, can exhibit amounts of change in insertion force, maximum retention force, and adhesion peak height, suppressed to low values. This means that the Ag—Sn covering layer 14 is hardly changed in chemical state and mechanical characteristics even after a lapse of a long time and the initial characteristics of a connection terminal are highly maintained. Thus, a connection terminal having the Ag—Sn covering layer 14 after reflow heating is a terminal exhibiting stable characteristics even after storage and use at a high temperature over a long period.

In general, when a Sn covering layer is formed on a surface of a connection terminal, it is important for suppression of the occurrence of whiskers to apply a reflow treatment. If a reflow treatment is tried to be applied to the Sn covering layer 15 in the case of the Sn covering layer 15 and Ag—Sn covering layer 14 formed in different regions on a surface of the same connection terminal, as in the press-fit terminal 2 described above, the Ag—Sn covering layer 14 is also heated together to a temperature equal to or more than the melting point of Sn. As described above, even if the Ag—Sn covering layer 14 is heated to a temperature equal to or more than the melting point of Sn, characteristics of a connection terminal, and the changes in such characteristics after a lapse of time and after heating are not remarkably degraded. Accordingly, a connection terminal constituted from the metal material 1 including the Sn covering layer 15 and the Ag—Sn covering layer 14 in different regions, as in the press-fit terminal 2, can be simply produced through a process of reflow heating the entire region of the metal material 1. The Sn covering layer 15, after reflow heating, can be suppressed in occurrence of whiskers, and thus the Ag—Sn covering layer 14 experiences progress in stabilization of a chemical state, including suppression of sulfurization, and thus allows the entire connection terminal to exhibit high resistance to the change over time.

### EXAMPLES

Hereinafter, Examples are shown. Herein, the present invention is not limited to these Examples. Hereinafter, unless particularly noted, each sample is produced and evaluated at room temperature in the atmosphere.

[1] Production of Sample

A Ni intermediate layer having a thickness of 3 μm was formed on a surface of a clean Cu substrate, according to electrolytic plating method. Furthermore, a surface of the Ni intermediate layer was subjected to Ag strike plating, to thereby form a strike layer having a thickness of 0.03 μm. Furthermore, a metal layer including both Ag and Sn and having a thickness of 0.35 μm was formed on a surface of the Ag strike layer, according to an electrolytic plating method. This sample was heated at 350° C. for 15 seconds, to thereby form an Ag—Sn alloy, forming an Ag—Sn precursor layer. The resultant was adopted as Sample 1. Herein, a sample where no Ag strike layer was formed was also prepared for hardness measurement.

Next, Sample 1 was reflow heated. The reflow heating was performed by heating Sample 1 at 330° C. as a temperature equal to or more than the melting point of Sn, for 11 seconds. A sample having an Ag—Sn covering layer after the reflow heating was adopted as Sample 2.

Furthermore, each metal material (board thickness t=0.6 mm) according to Sample 1 and Sample 2 was used as a raw material, to thereby produce an N-type press-fit terminal having a shape illustrated in FIG. 2. An Ag—Sn precursor layer (Sample 1) or an Ag—Sn covering layer (Sample 2) was placed at least on a surface of a board connection portion in the press-fit terminal. A circuit board was also prepared which included, as a through-hole adapted to the press-fit terminal, a through-hole having a hole size of 1.0 mm and having a Sn plated layer on an inner periphery thereof.

[2] Evaluation of State of Ag—Sn Covering Layer in Initial State

### (1) Test Method

Each metal material according to Samples 1 and 2 produced as described above was performed to SEM observation and EBSD measurement. SEM observation was performed with respect to a surface of such each metal material. EBSD measurement was performed with respect to a sample obtained by cutting at a section perpendicular to the surface of such each metal material, and also a sample obtained by cutting at a section in parallel with the surface of such each metal material. The results of EBSD measurement were used to evaluate a crystal grain size distribution based on a crystal grain distribution image, and also evaluate an orientation distribution and a plastic strain distribution based on an inverse pole figure (IPF) map.

Furthermore, the surface hardness of such each metal material according to Samples 1 and 2 was measured. An ultrafine hardness meter was used in the measurement. The test load was 100 nN, and the measurement was performed in screw-down conditions of loading for 10 seconds, retention for 20 seconds, and unloading for 10 seconds. The number of measurement samples was 7, and the median value of those at five points was adopted (N=5).

### (2) Results

(2-1) SEM Observation

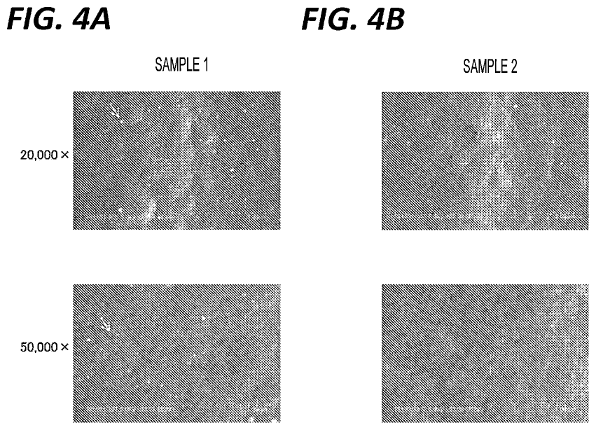

FIGS. 4A and 4B illustrate respective SEM images (secondary electron images) of Samples 1 and 2. FIG. 4A corresponds to Sample 1 and FIG. 4B corresponds to Sample 2, and each of FIGS. 4A and 4B illustrates a low-magnification image (20,000×; total scale corresponding to 2.0 m) in the upper section and a high-magnification image (50,000×; total scale corresponding to 1.0 m) in the lower section. Each of the acceleration voltages is 5 kV.

With reference to the SEM images, many granules brightly observed are scattered in the field of view, as indicated by an arrow, with respect to Sample 1 in FIG. 4A. These granules are more brightly observed than the surrounding in a secondary electron image, and thus are presumed to be formed from an alloy larger in average atomic weight than an Ag—Sn alloy constituting an underlying Ag—Sn precursor layer and higher in ratio of Sn than Sn or an Ag—Sn alloy constituting the Ag—Sn precursor layer. It is considered that the Ag—Sn precursor layer constituting Sample 1 does not undergo any reflow heating and does not sufficiently experience progress in alloying between Ag and Sn and thus such granules high in Sn concentration are generated on a surface.

On the other hand, a surface high in smoothness is observed in the SEM image of Sample 2 in FIG. 4B, and the granules observed with respect to Sample 1 in FIG. 4A, while present, are remarkably reduced in number thereof as compared with the case of Sample 1. The number of granules present in the field of view in the low-magnification image in the upper section is about 10 or less. In other words, it can be seen that any granule high in Sn concentration significantly disappears by reflow heating at a temperature equal to or more than the melting point of Sn. It can be interpreted from this result that alloying progresses by reflow heating and then most of Sn used as a raw material is taken together with Ag to form an alloy, and the alloy is incorporated into the Ag—Sn covering layer. The density of granules in Sample 2 is estimated to be 0.5/μm² or less.

(2-2) EBSD Measurement

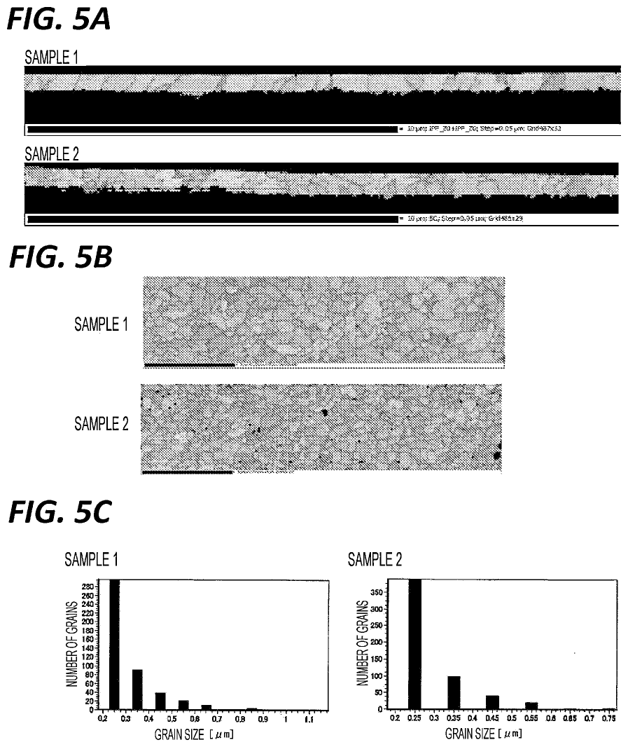

Next, FIGS. 5A and 5B illustrate band contrast (BC) images by EBSD, as obtained from metal materials according to Sample 1 and Sample 2. FIG. 5A illustrates images of cross sections perpendicular to surfaces and FIG. 5B illustrates images of cross sections in parallel with such surfaces, and each thereof represents the image of Sample 1 in the upper section and the image of Sample 2 in the lower section. The BC images each represent a crystal grain distribution, and the scale bar in FIG. 5A corresponds to 10 μm and the scale bar in FIG. 5B corresponds to 5 μm. FIG. 5C represents grain size distributions obtained from the images of the cross sections in parallel with such surfaces in FIG. 5B, as bar graphs. The left section represents Sample 1 and the right section represents Sample 2, and the horizontal axis represents the grain size and the vertical axis represents the number of grains. Furthermore, representative values in the grain size distributions obtained from the images in FIG. 5B are summarized in Table 1 below.

TABLE 1

| | Crystal grain size (μm) | | |
|---|---|---|---|
| | Average value | Minimum value | Maximum value |
| Sample 1 | 0.28 | 0.18 | 1.18 |
| Sample 2 | 0.25 | 0.18 | 0.77 |

With reference to the crystal grain distribution images in FIGS. 5A and 5B, in particular, the distribution images of cross sections in parallel with surfaces in FIG. 5B, a higher density at the grain boundary and a crystal grain distribution smaller in grain size as a whole are observed in Sample 2 than in Sample 1. Such a tendency is further clearly demonstrated by the grain size distributions in FIG. 5C and the grain size values in Table 1, and many grains are more distributed in a region where the grain size is smaller, in Sample 2. It can be seen from this result that the crystal grain size is smaller in the Ag—Sn covering layer subjected to reflow heating at a temperature equal to or more than the melting point of Sn.

The change in crystal grain size by reflow heating is examined in further detail. It can be seen with reference to the results in FIGS. 5A to 5C and Table 1 that crystal grain refinement in Sample 2 after reflow heating occurs mainly in the form of a decrease of any crystal grain having a large grain size. In particular, it can be seen with reference to Table 1 that the minimum grain size values in Sample 1 and Sample 2 are not changed, but the average value in Sample 2 is smaller. Furthermore, the maximum grain size value is remarkably decreased over an extent of decrease in average value, in Sample 2, as compared with that in Sample 1. It can be thus said that reflow heating mainly serves to eliminate a crystal grain large in size in the Ag—Sn covering layer. The crystal grain size in Sample 2 is less than 0.28 μm in terms of average value.

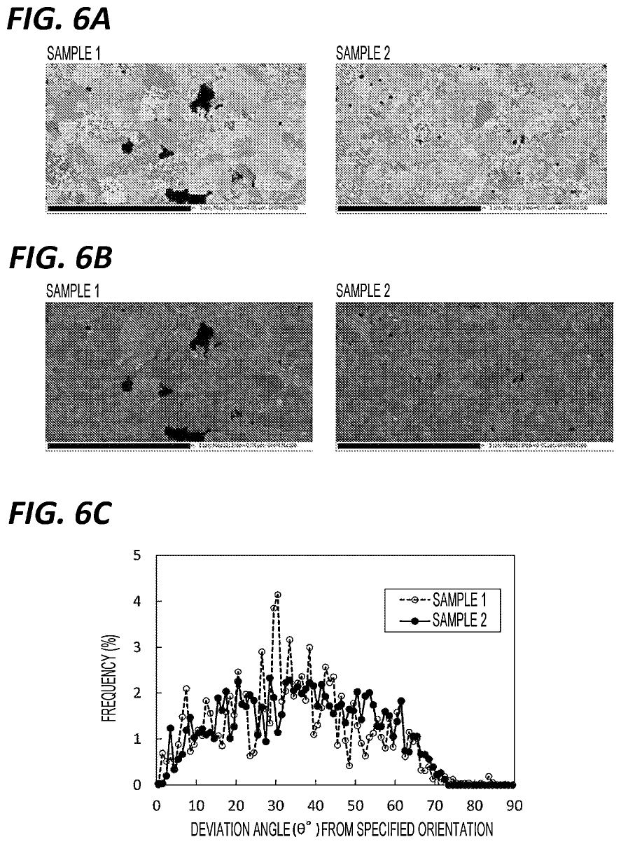

Furthermore, FIGS. 6A to 6C illustrate the results of orientation analysis by EBSD, in cross sections in parallel with surfaces of metal materials according to Sample 1 and Sample 2. FIG. 6A illustrates specified orientation distributions based on IPF maps and FIG. 6B illustrates plastic strain distributions, and each of the FIGS. 6A and 6B represents the results in Sample 1 in the left section and the results in Sample 2 in the right section. All the scale bars correspond to 5 μm. FIG. 6C represents the frequencies of deviation angles from specified orientations of Samples 1 and 2, obtained based on IPF maps. Each horizontal axis represents the deviation angle from a specified orientation, and each vertical axis represents the frequency of each deviation angle, in terms of proportion under the assumption that the total of all deviation angles is 100%. The specified orientation here refers an orientation accounting for the largest proportion, among all orientations, and corresponds to the <012> direction in both Samples 1 and 2.

First, it can be seen from the specified orientation distributions in FIG. 6A that the crystal grain in Sample 2 is refined after reflow heating, as compared with that in Sample 1, as found in the crystal grain distributions in FIG. 5A. Furthermore, it can be seen from the plastic strain distributions in FIG. 6B that the plastic strain at the grain boundary in Sample 2 is reduced after reflow heating, as compared with that in Sample 1, and removal of strain occurs. Furthermore, it can be seen from the distributions of deviation angles from specified orientations in FIG. 6C that the deviation angle in Sample 2 is more highly uniformly distributed in a wide range, than that in Sample 1. While the frequency value in a partial of the deviation angle in Sample 1 exceeds 2.5%, the frequency value in the entire region of the deviation angle in Sample 2 is 2.5% or less.

The above results of EBSD analysis indicate that reflow heating is conducted to thereby allow the Ag—Sn covering layer to be not only reduced in residual stress, but also enhanced in crystal grain crystallinity. Thus, crystal grain refinement by reflow heating, which is clear from FIGS. 5A to 5C, can correspond to recrystallization and crystal grain rearrangement along with relaxing of the residual stress in the Ag—Sn layer.

(2-3) Hardness Measurement

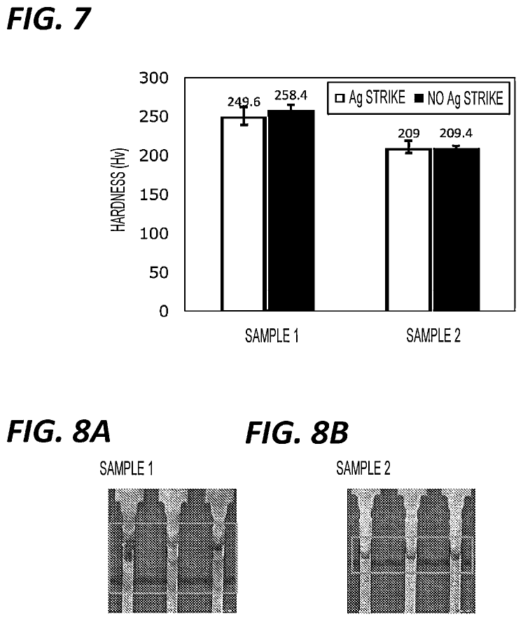

FIG. 7 illustrates the results of hardness measurement of metal materials according to Sample 1 (the left section) and Sample 2 (the right section). Each hardness (unit: Hv) measured in the case of formation of an Ag strike layer (Ag strike) and in the case of no formation thereof (no Ag strike) is represented in a bar graph. Each error bar indicates the variation among five samples.

According to the results in FIG. 7, a high degree of hardness of more than 240 Hv is obtained in Sample 1 before reflow heating, regardless of the presence of the Ag strike layer. On the other hand, the degree of hardness in Sample 2 after reflow heating is decreased as compared with that in Sample 1. In other words, it can be seen that the Ag—Sn covering layer is softened after reflow heating. However, a degree of hardness of 180 Hv or more is maintained even in Sample 2 after reflow heating, and it can be said that material strength sufficient for a constituent material of an electric connection member such as a connection terminal is kept. The presence of the Ag strike layer has almost no influence on the degree of hardness of the Ag—Sn covering layer, also in Sample 2.

(2-4) Conclusion

According to the above results of SEM observation and EBSD analysis, and hardness measurement, the Ag—Sn covering layer experiences progress in alloying and also is enhanced in crystallinity due to reflow heating. As a result, chemical stability of the Ag—Sn covering layer is enhanced and also crystal grain refinement occurs. The crystal grain size is decreased to less than 0.28 μm in terms of average value. The hardness of the Ag—Sn covering layer is maintained at a level of 180 Hv or more, although is slightly decreased due to reflow heating.

[3] Change of Ag—Sn Covering Layer Left at High Temperature

(1) Test Method

Each metal material according to Samples 1 and 2 produced as described above was investigated about the change generated after such each metal material was under the following two acceleration degradation conditions.
Medium temperature conditions: left in the atmosphere at 50° C.
High-temperature and high-humidity conditions: left in the air at a temperature of 85° C. and a humidity of 85% RH. Being left under the conditions for 24 hours corresponded to being left in the atmosphere at room temperature for half a year. And being left for 480 hours corresponded to being left in the atmosphere at room temperature for ten years.

First, blackening due to sulfurization was evaluated. Specifically, each connection terminal according to Samples 1 and 2 was placed under medium temperature conditions for 155 days, and the surface state was visually observed and compared with that in the initial state.

Furthermore, a cross section of such each metal material according to Samples 1 and 2 was observed with SEM after lapses of 24 hours and 480 hours under high-temperature and high-humidity conditions, and compared with that in the initial state, in order that the surface state was confirmed after left at a high temperature. In the SEM observation, elemental analysis by energy dispersive X-ray analysis (EDX) was also performed.

Furthermore, such each metal material according to Samples 1 and 2, after lapses of 24 hours and 480 hours under high-temperature and high-humidity conditions, was subjected to depth analysis XPS measurement. The measurement was performed by use of Al-Kα radiation as a radiation source with sputtering of Ar on each sample surface. The depth distribution of the concentration of each constituent element was estimated based on the measurement results.

(2) Results

(2-1) Observation of Surface of Connection Terminal

FIGS. 8A and 8B respectively illustrate photographs taken after a connection terminal according to Sample 1 and a connection terminal according to Sample 2 are left under medium temperature conditions for 155 days. FIG. 8A illustrates a photograph of Sample 1 and FIG. 8B illustrates a photograph of Sample 2. These photographs are each taken with enlargement of a position adjacent to the board connection portion in a linear moiety connecting the board connection portion and the terminal connection portion in the press-fit terminal. In each of the photographs, a region where blackening due to sulfurization is easily found is represented with being surrounded by a rectangle.

In the photograph of Sample 1 in FIG. 8A, blackening of the connection terminal occurs in a wide area along with a longitudinal direction of the terminal. On the other hand, in Sample 2 having the Ag—Sn covering layer subjected to reflow heating, an area where blackening of the connection terminal occurs is clearly decreased as in FIG. 8B, as compared with the case of Sample 1. This result indicates that the Ag—Sn covering layer is hardly sulfurized by the sulfur content in the atmosphere, due to reflow heating. It is considered that the Ag—Sn covering layer experiences progresses in alloying and enhancement in crystallinity due to reflow heating to result in an enhancement in chemical stability of an Ag—Sn alloy and to hardly cause the occurrence of a reaction of an Ag atom with a sulfur molecule contained.

(2-2) Observation with SEM

Cross sections were observed with SEM, and, while publication of observation images thereof was omitted, both Samples 1 and 2, after a lapse of 24 hours under high-temperature and high-humidity conditions, were not observed to be remarkably changed in cross section structure of the Ag—Sn covering layer, as compared with that in the initial state. The results of elemental analysis by EDX were also not found to be largely changed after only a lapse of only 24 hours under high-temperature and high-humidity conditions.

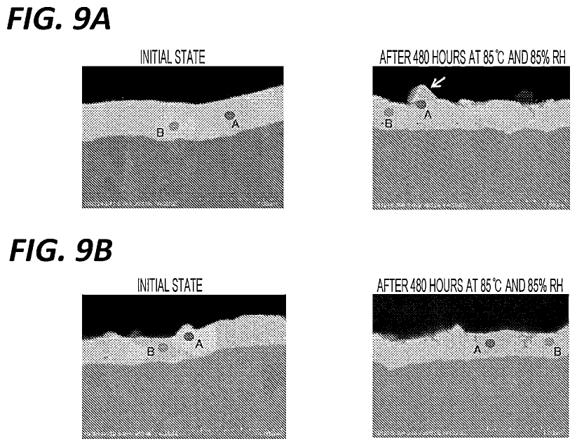

On the other hand, the cross section structure of the Ag—Sn covering layer was observed to be changed after a lapse of 480 hours under high-temperature and high-humidity conditions, as compared with that in the initial state. FIGS. 9A and 9B illustrate SEM images (secondary electron images) by observation of cross sections of each metal material according to Samples 1 and 2, in the initial state and in the state after a lapse of 480 hours under high-temperature and high-humidity conditions. FIGS. 9A and 9B each illustrate the initial state in the left section, and the state after a lapse of 480 hours under high-temperature and high-humidity conditions, in the right section. The scale represents 1.0 μm.

Furthermore, the results of the Ag concentrations at places indicated by circles in each image, measured by EDX, are shown in Table 2 below. The Ag concentrations detected at respective positions represented by Symbols A and B in each image are represented (unit: % by atom).

TABLE 2

Ag Concentration (% by atom)

| | | | High temperature |
|---|---|---|---|
| | | | and high humidity |
| | | Initial state | After 480 hours |
| Sample 1 | Position A | 81.5 | 83.8 |
| | Position B | 80.4 | 84.3 |
| Sample 2 | Position A | 83.1 | 84.0 |
| | Position B | 83.7 | 83.6 |

First, with reference to the SEM images of the initial states in the left sections in FIGS. 9A and 9B, each Ag—Sn layer in both Samples 1 and 2 is clearly observed as a strip-shaped layer having medium brightness, at the midpoint in a vertical direction in each of the images. While almost the entire balance except for Ag in the alloy composition in the Ag—Sn covering layer, as analyzed by EDX, is considered to correspond to Sn, the Ag concentration of Sample 2 is slightly higher than that of Sample 1 in the initial state, according to the analysis results shown in Table 2. Such a difference in Ag concentration is considered to result from progress of alloying by reflow heating. The Ag concentrations at Position A and Position B are almost the same in both Samples 1 and 2. Position A and Position B are set in adjacent regions with forming a light-dark contrast in each of the images, and it can be said that there is almost no difference in alloy composition between these regions.

Next, the change of each sample left under high-temperature and high-humidity conditions for 480 hours is examined. First, when the SEM images of the initial state (left) and the state (right) after a lapse of 480 hours under high-temperature and high-humidity conditions are visually compared with respect to Sample 1 in FIG. 9A, a smooth face in the Ag—Sn layer is exposed on the outermost surface in the initial state, whereas a granular precipitate indicated by an arrow is generated on the outermost surface after a lapse of 480 hours under high-temperature and high-humidity conditions. The component composition of such a granulated substance is confirmed by EDX, and Ag occupies 100%. In other words, a grain of a pure Ag metal is precipitated on the surface. It is considered that, in Sample 1, no reflow heating is performed after alloy formation and thus alloying between Ag and Sn does not sufficiently progress and an Ag atom not forming any alloy with Sn and an Ag atom forming only an alloy low in stability are precipitated on the surface by heating under high-temperature and high-humidity conditions, to form a grain.

On the other hand, in Sample 2 in FIG. 9B, the degree of smoothing on the outermost surface is almost not changed between the initial state (left) and the state (right) after a lapse of 480 hours under high-temperature and high-humidity conditions, and a phenomenon does not occur where a grain does not present in the initial state is generated on the surface subjected to high-temperature and high-humidity conditions. In other words, no Ag grain is formed on the surface in Sample 2 after reflow heating, even after the Sample is under high-temperature and high-humidity conditions, unlike Sample 1 after no reflow heating. It is presumed that the phenomenon results from progress of alloying and also an enhancement in crystallinity in the Ag—Sn covering layer after reflow heating, and thus an enhancement in stability of an alloy texture in the Ag—Sn covering layer.

When the Ag concentrations shown in Table 2 are compared between the initial state and the state after a lapse of 480 hours under high-temperature and high-humidity conditions, the Ag concentration of Sample 1 is increased due to high-temperature and high-humidity conditions. It is considered that such an increase in Ag concentration results from progress of alloying which is not completely made in the initial state, but made after heating under high-temperature and high-humidity conditions. On the other hand, an increase in Ag concentration of Sample 2 is kept slightly small after the Sample is under high-temperature and high-humidity conditions. This result is interrupted to be due to high progress of alloying and thus sufficient stabilization of an alloy texture in the Ag—Sn covering layer by reflow heating and furthermore no more progress of alloying even after heating under high-temperature and high-humidity conditions, in Sample 2. Thus, the alloy texture in the Ag—Sn covering layer after reflow heating is enhanced in stability by reflow heating, and thus the Ag—Sn covering layer is hardly changed in state, for example, hardly has an Ag grain generated and is hardly changed in alloy composition in the layer, even when placed under high-temperature and high-humidity conditions corresponding to the state after a lapse of a long time in the atmosphere, and thus a stable covering structure is maintained.

(2-3) Evaluation by XPS

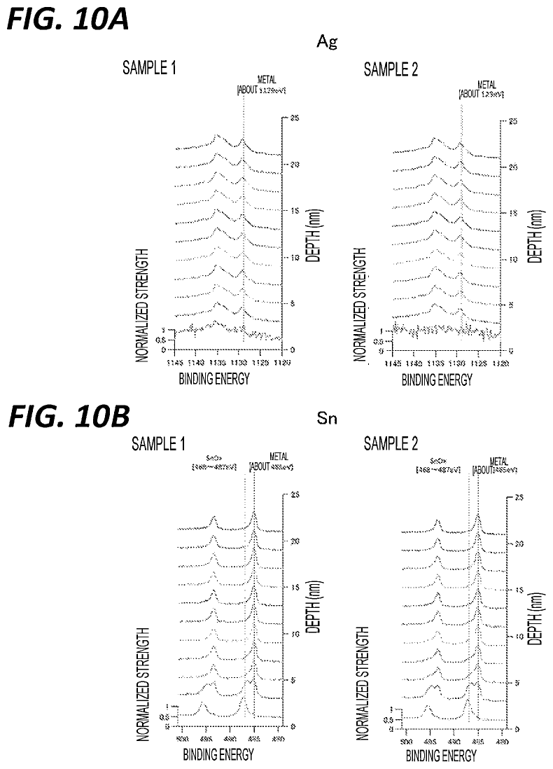

Next, the results of evaluation of an element distribution in the Ag—Sn covering layer, with depth analysis XPS, are examined. First, as examples, spectra of Ag and Sn measured with respect to Samples 1 and 2 in the initial state are illustrated in FIGS. 10A and 10B. FIG. 10A illustrates those in an Ag MVV auger region and FIG. 10B those in a Sn3d photoelectron region (3d_{5/2} and 3d_{3/2}). FIGS. 10A and 10B each illustrate the measurement results in Sample 1 in the left section and the measurement results in Sample 2 in the right section. In each of FIGS. 10A and 10B, spectra obtained by measurement in different depths are represented in tandem and the depth position from the outermost surface is represented on the right axis (unit: nm). Those represented in the lower section correspond to the results measured at the outermost surface side, and those represented in the upper section correspond to the results measured at the inside of the layer. The horizontal axis represents the electron binding energy. In each of FIGS. 10A and 10B, the binding energies of the metallic state (zero-valent) and corresponding to the oxide state are represented by solid lines.

According to the spectra in FIGS. 10A and 10B, it is confirmed in both Samples 1 and 2 that both Ag and Sn are observed in the entire region including a slightly shallow region of a surface and an Ag—Sn alloy is exposed on the outermost surface of the Ag—Sn covering layer. In focusing on the chemical shift of Ag, only a peak assigning to the metallic state is observed regardless of the depth and no peak assigned to oxide is observed at a higher binding energy side, with respect to both Samples 1 and 2. On the other hand, in focusing on the chemical shift of Sn, not only a peak of the metallic state, but also a peak of oxide (SnOx) is observed at a shallow position, with respect to both Samples 1 and 2. It can be thus seen that an O atom is bound not to an Ag atom, but to a Sn atom in the occurrence of surface oxidation in both Samples 1 and 2. Although publication of any spectrum is omitted, a tendency where an O atom is preferentially bound to a Sn atom is not changed even if oxidation further progresses due to high-temperature and high-humidity conditions. However, when oxidation and sulfurization progress after a lapse of 480 hours under high-temperature and high-humidity conditions, there arise components of binding energies for an Ag oxide and an Ag sulfide in the immediate vicinity (a depth of less than 5 nm) of the outermost surface.

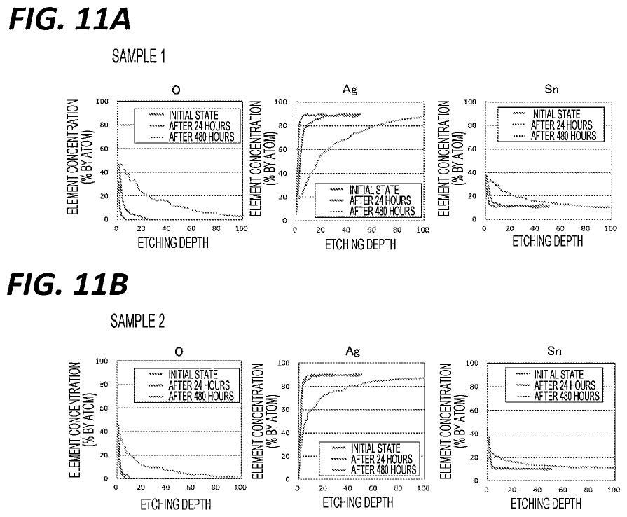

FIGS. 11A and 11B illustrate depth distributions in Samples 1 and 2, as evaluated about the depth distribution of the concentration with respect to each element of O, Ag, and Sn based on the results of XPS measurement, as exemplified in FIGS. 10A and 10B. The vertical axis represents the element concentration (unit: % by atom) and the horizontal axis represents the depth position (unit: nm) from the outermost surface. All the Ag and Sn concentrations are estimated based on integrated intensities without separation of each of such spectra in FIGS. 10A and 10B into that assigned to the metallic state and that assigned to the oxide state. Although publication with respect to O is omitted, the concentration is estimated based on the integrated intensity of a peak assigned to an O1s photoelectron. FIGS. 11A and 11B collectively illustrate the results in the initial state and the states after lapses of 24 hours and 480 hours under high-temperature and high-humidity conditions, with respect to each element of O, Ag and Sn.

First, focusing on the concentration distribution of an O atom is made. In Sample 1 in FIG. 11A, an increase in O concentration occurs over a region from the outermost surface to a depth of about 20 nm after a lapse of 24 hours under high-temperature and high-humidity conditions, as compared with that in the initial state. In other words, oxidation progresses due to high-temperature and high-humidity conditions. An increase in O concentration further remarkably occurs after a lapse of 480 hours, and a remarkable increase in O concentration occurs in a region to a depth of 100 nm or more. The O concentration at a position of a depth of 20 nm reaches approximately 23% by atom.

On the other hand, with reference to the results in Sample 2 in FIG. 11B, the concentration distribution of an O atom is almost not changed after a lapse of only 24 hours under high-temperature and high-humidity conditions, as compared with that in the initial state. In other words, oxidation in the Ag—Sn covering layer does not substantially progress due to a lapse of only 24 hours even under high-temperature and high-humidity conditions. On the other hand, an increase in O concentration is observed after a lapse of 480 hours under high-temperature and high-humidity conditions and then oxidation progresses. However, in Sample 2, when the amount of increase in O concentration is compared with that in Sample 1, the O concentration at each depth position is lower and the depth in a region where an O atom is distributed is also shallower. In other words, it can be seen that the degree of progress of oxidation is low and only a thin oxidized film is formed in Sample 2, as compared with Sample 1. The O concentration at a position of a depth of 20 nm in Sample 2 is approximately 10% by atom even after the Sample is left under high-temperature and high-humidity conditions for 480 hours, and is suppressed to be equal to or less than half that in Sample 1.

Thus, it is considered that the result where Sample 2 after reflow heating is suppressed in progress of oxidation due to such heating is due to an enhancement in chemical stability of the Ag—Sn covering layer after progress of alloying and an enhancement in crystallinity due to reflow heating. As illustrated in FIGS. 8A and 8B, the Ag—Sn covering layer is stabilized after reflow heating and thus is also suppressed in sulfurization in the surface, and suppression of oxidation in the Ag—Sn covering layer can also be seen as an index of suppression of sulfurization.

Next, focusing on the concentration distribution of an Ag atom is made. In Sample 1 in FIG. 11A, the Ag concentration is decreased generally in a region from the outermost surface to a depth of about 20 nm after the Sample is left under high-temperature and high-humidity conditions for 24 hours, as compared with that in the initial state. In other words, the alloy composition in the vicinity of the outermost surface is changed due to high-temperature and high-humidity conditions. The amount of decrease in Ag concentration is larger after a lapse of 480 hours under high-temperature and high-humidity conditions, and an area where such a decrease occurs also reaches a deeper region. The amount of decrease in Ag concentration at a position of a depth of 20 nm reaches approximately 37% relative to that in the initial state.

On the other hand, with reference to the results in Sample 2 in FIG. 11B, the concentration distribution of an Ag atom is almost not changed even after the Sample is left under high-temperature and high-humidity conditions for 24 hours, as compared with that in the initial state. In other words, the change in alloy composition does not occur in the Ag—Sn covering layer after a lapse of only 24 hours even under high-temperature and high-humidity conditions. On the other hand, a decrease in Ag concentration is observed and the change in alloy composition progresses after a lapse of 480 hours under high-temperature and high-humidity conditions. However, the amount of decrease in Ag concentration of Sample 2 is smaller in terms of degree of decrease at each depth position, than that of Sample 1. In other words, it can be seen that the degree of change in alloy composition in Sample 2 is lower. The amount of decrease in Ag concentration at a position of a depth of 20 nm in Sample 2 is approximately 20% even after the Sample is left under high-temperature and high-humidity conditions for 480 hours, relative to that in the initial state, and is suppressed to be nearly half the rate of decrease in the case of Sample 1.

Thus, it is considered that the result where Sample 2 after reflow heating is suppressed in change in alloy composition is due to an enhancement in chemical stability of the Ag—Sn covering layer after progress of alloying and an enhancement in crystallinity due to reflow heating. Also when the Sn atom concentration distribution behaviors are visually compared in FIGS. 11A and 11B, a tendency is demonstrated where the change in alloy composition after the Sample is under high-temperature and high-humidity conditions is suppressed due to reflow heating, although such a tendency is not remarkably demonstrated as compared with the case of Ag.

(2-4) Conclusion

According to the above measurement results of observation of surface blackening, SEM observation, and depth analysis XPS, the Ag—Sn covering layer is suppressed in sulfurization and progress of oxidation due to reflow heating, even if subsequently left at a high temperature or left for a long period, and also hardly causes formation of an Ag grain in a layer surface and the change in alloy composition in the layer. This result can be interrupted to result from the occurrence of progress of alloying and an enhancement in crystallinity due to reflow heating and thus an enhancement in chemical stability of the Ag—Sn covering layer.

[4] Changes in Characteristics of Connection Terminal Left at High Temperature

(1) Test Method

Each connection terminal of Samples 1 and 2 produced as described above was placed under medium temperature conditions and high-temperature and high-humidity conditions, and characteristics thereof in insertion and removal into and from a through-hole were compared with those in the initial state. In the test, while the board connection portion of the press-fit terminal was displaced in a direction of insertion into and a direction of removal from a through-hole along with an axial line direction, the load applied to the connection terminal was measured with a load cell. The measurement was performed ten times (N=10) with respect to each of the Samples.

(2) Results

FIGS. 12A and 12B illustrate the measurement results in Sample 2 after a lapse of 155 days under medium temperature conditions, as examples of respective load displacement curves in terminal insertion and removal. The horizontal axis represents the amount of displacement of the connection terminal and the vertical axis represents the load applied. First, the load is gradually increased relative to the amount of displacement in a region where the amount of displacement is small, and then a region follows thereto where the load is less changed relative to the amount of displacement, in the load displacement curve in terminal insertion, as illustrated in FIG. 12A. The maximum value A1 of the load in this behavior corresponds to the insertion force. Next, a precipitous peak rises up in a region where the amount of displacement is small, and then the load is decreased, in the load displacement curve in terminal removal, as illustrated in FIG. 12B. After such a decrease, a flat zone where the load is almost not changed relative to the amount of displacement is observed. In this behavior, the load value A2 at the peak top corresponds to the maximum retention force, and the difference in load between the peak height A3 at the initial rising-up, namely, the peak top, and that in the flat zone corresponds to the adhesion peak height. While the publication is omitted, the same tendencies of increase and decrease in load in the load displacement curves in terminal insertion and removal are demonstrated in both Samples 1 and 2 also in all the initial state, the state after such Sample is under medium temperature conditions, and the state after such Sample is under high-temperature and high-humidity conditions, and the insertion force, the maximum retention force, and the adhesion peak height can be each read.

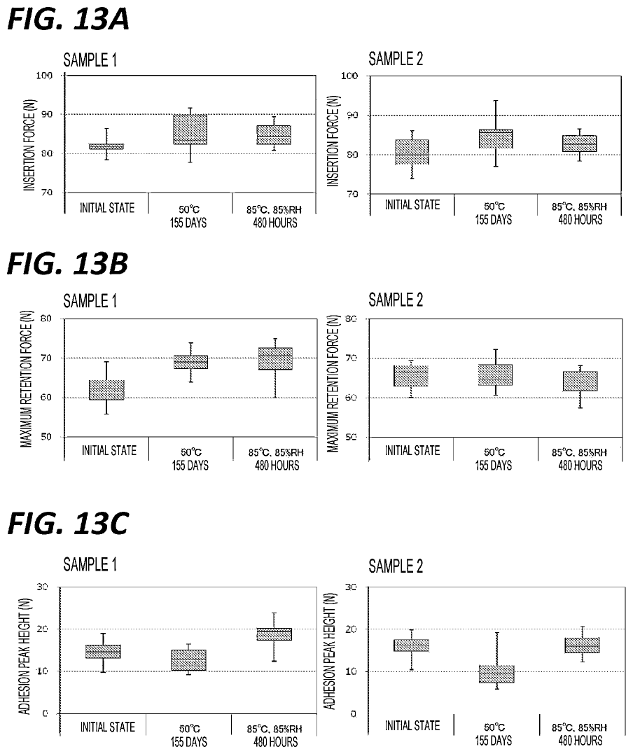

FIGS. 13A to 13C represents respectively the insertion force, the maximum retention force, and the adhesion peak height, with boxplots. Each of FIGS. 13A to 13C illustrates the measurement results in Sample 1 in the left section and the measurement results in Sample 2 in the right section, and represents in tandem the respective results in the initial state, the state after a lapse of 155 days under medium temperature conditions, and the state after a lapse of 480 hours under high-temperature and high-humidity conditions. In each boxplot, the horizontal line represents the median value and the box represents a range from a value of 25% to a value of 75%. Each error bar represents a range from the minimum value to the maximum value.

First, with reference to the behavior of the insertion force in FIG. 13A, each of Samples 1 and 2 is increased in terminal insertion force after such Sample is under medium temperature conditions and under high-temperature and high-humidity conditions. The rate of increase with respect to Sample 2 is slightly higher than that with respect to Sample 1. However, the rate of increase in insertion force relative to that in the initial state, in Sample 2, is suppressed to low values in terms of median values, 7% after a lapse of 155 days under medium temperature conditions and 3% after a lapse of 480 hours under high-temperature and high-humidity conditions.

Next, with reference to the behavior of the maximum retention force in FIG. 13B, Sample 1 is increased in maximum retention force after the Sample is under medium temperature conditions and under high-temperature and high-humidity conditions, whereas Sample 2 is not remarkably changed in maximum retention force even after the Sample is under medium temperature conditions and under high-temperature and high-humidity conditions. The rate of change in maximum insertion force relative to that in the initial state, with respect to Sample 2, is suppressed to very low values in terms of median values, 3% after a lapse of 155 days under medium temperature conditions and 2% after a lapse of 480 hours under high-temperature and high-humidity conditions.

Finally, with reference to the behavior of the adhesion peak height in FIG. 13C, each of Samples 1 and 2 is lowered in adhesion peak height after such Sample is under medium temperature conditions, compared with that in the initial state. After such Sample is under high-temperature and high-humidity conditions, Sample 1 is slightly increased in value, as compared with that in the initial state, and Sample 2 is comparable in value with that in the initial state. The rate of change in adhesion peak height relative to that in the initial state, in Sample 2, is suppressed to low values in terms of median values, 33% after a lapse of 155 days under medium temperature conditions and 1% after a lapse of 480 hours under high-temperature and high-humidity conditions.

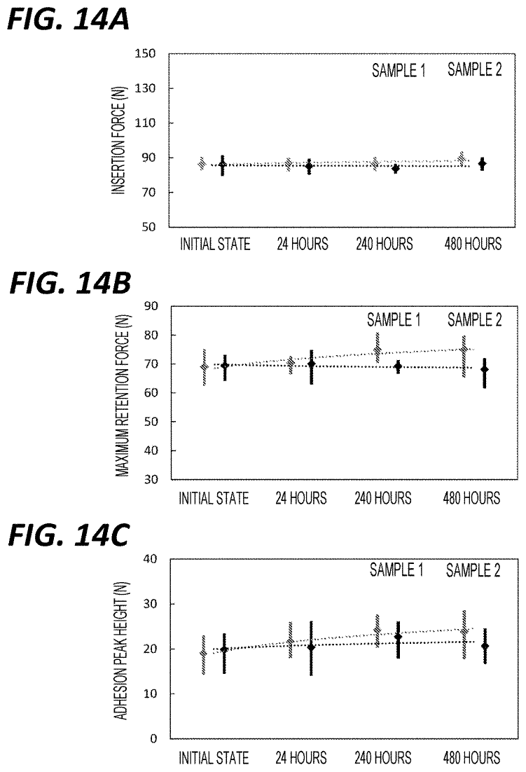

Furthermore, FIGS. 14A to 14C illustrate the respective changes in insertion force, maximum retention force, and adhesion peak height over time under high-temperature and high-humidity conditions. In each of FIGS. 14A to 14C, the measurement results in Samples 1 and 2 are illustrated together, and respective points of data represent the results in the initial state, and the states after lapses of 24 hours, 240 hours, and 480 hours under high-temperature and high-humidity conditions. The approximate curves are also represented.

According to FIGS. 14A to 14C, the amount of change in measurement value according to the lapse time under high-temperature and high-humidity conditions is smaller in all the insertion force, the maximum retention force, and the adhesion peak height in Sample 2 after reflow heating, than that in Sample 1 after no reflow heating in the initial state. In particular, the maximum retention force in FIG. 14B and the adhesion peak height in FIG. 14C are observed to be monotonically increased according to the lapse time in Sample 1, whereas the values thereof in Sample 2 are almost not changed according to the lapse time. It can be said from these results that the changes in characteristics in terminal insertion and removal hardly progress any more in Sample 2 even if the Sample is left in the atmosphere over a half year corresponding to 24 hours under high-temperature and high-humidity conditions.

From the above results, the rates of change in characteristics in insertion and removal of a connection terminal, under medium temperature conditions and high-temperature and high-humidity conditions, are suppressed to low values in Sample 2 where the Ag—Sn covering layer is reflow heated, and these rates of change are at least not remarkably increased as compared with those in Sample 1 after no reflow heating. It can also be said that, after the changes in characteristics occur at levels corresponding to those after a lapse of half year in the atmosphere, these changes over time hardly progress any more. These results are interrupted to be due to an enhancement in stability in the Ag—Sn covering layer by reflow heating, and also maintaining of material strength of the Ag—Sn covering layer, typified by hardness, at a high level, as confirmed in the above various tests.

While embodiments of the present disclosure are described above in detail, the present invention is not limited to the embodiments at all and can be variously modified without departing from the gist of the present invention.

### LIST OF REFERENCE NUMERALS

1 metal material
11 substrate
12 intermediate layer
13 Ag strike layer
14 Ag—Sn covering layer
15 Sn covering layer
2 press-fit terminal
20 board connection portion
21 swollen piece
22 contact portion
25 terminal connection portion
3 connector for board
31 connector housing

1. A metal material comprising
a substrate, and
an Ag—Sn covering layer that covers a surface of the substrate, wherein
the Ag—Sn covering layer contains Ag and Sn and has an Ag—Sn alloy exposed on a surface thereof, and
an average crystal grain size in a cross section in parallel with a surface of the Ag—Sn covering layer is less than 0.28 μm.

2. A metal material,
produced by forming a metal layer including Ag and Sn, on a surface of a substrate, and heating the resultant at a temperature equal to or more than the melting point of Sn, and
comprising an Ag—Sn covering layer containing Ag and Sn and having an Ag—Sn alloy exposed on a surface thereof, on the surface of the substrate.

3. The metal material according to claim 1, wherein a maximum crystal grain size in a cross section in parallel with the surface of the Ag—Sn covering layer is 0.8 μm or less.

4. The metal material according to claim 1, wherein a frequency value of a deviation angle from an orientation accounting for the largest proportion in a crystal grain orientation in the cross section in parallel with the surface of the Ag—Sn covering layer is 2.5% or less in an entire region of the deviation angle.

5. The metal material according to claim 1, wherein
a region in which the Ag—Sn covering layer is formed, and
a region in which the Ag—Sn covering layer is not formed and a Sn covering layer constituted as a Sn layer or a Sn alloy layer containing Ag only as an unavoidable impurity covers the surface of the substrate
are formed at different positions on the surface of the substrate.

6. The metal material according to claim 1, wherein the Ag—Sn covering layer has a surface hardness of 180 Hv or more and 240 Hv or less.

7. The metal material according to claim 1, wherein the Ag—Sn covering layer has an oxygen concentration of 20% by atom or less at a position of a depth of 20 nm from the surface thereof when left in an environment at a temperature of 85° C. and a humidity of 85% RH for 480 hours.

8. The metal material according to claim 1, wherein the Ag—Sn covering layer has no Ag grain formed on the surface thereof when left in an environment at a temperature of 85° C. and a humidity of 85% RH for 480 hours.

9. The metal material according to claim 1, wherein
the substrate is constituted from Cu or a Cu alloy, and
the metal material further has an intermediate layer constituted from Ni or a Ni alloy between the substrate and the Ag—Sn covering layer.

10. The metal material according to claim 9, wherein
a region in which the Ag—Sn covering layer is formed, and
a region in which the Ag—Sn covering layer is not formed and a Sn covering layer constituted as a Sn layer or a Sn alloy layer containing Ag only as an unavoidable impurity covers the surface of the substrate
are formed on a continuous common surface of the intermediate layer, at different positions on the surface of the substrate.

11. The metal material according to claim 9, wherein the metal material further has an Ag strike layer between the Ag—Sn covering layer and the intermediate layer.

12. A connection terminal, constituted from the metal material according to claim 1, wherein
the Ag—Sn covering layer is formed on the surface of the substrate, at least in a contact portion to be in electric contact with a counter conductive member.

13. The connection terminal according to claim 12, wherein
the connection terminal is formed in an elongated manner,
the connection terminal has a first contact portion including the Ag—Sn covering layer, at one end in a longitudinal direction thereof, and
the connection terminal has a second contact portion including the Sn covering layer constituted as a Sn layer or a Sn alloy layer containing Ag only as an unavoidable impurity, at the other end in the longitudinal direction thereof.

14. The connection terminal according to claim 12, wherein
the connection terminal is formed as a press-fit terminal, and
the connection terminal has the Ag—Sn covering layer at a position where the press-fit terminal, when inserted into a through-hole, is contacted with an inner periphery of the through-hole.

15. The connection terminal according to claim 14, wherein
an insertion force in insertion of the connection terminal into the through-hole having a Sn layer in the inner periphery is suppressed to 20% or less in terms of amount of change after the connection terminal is left in the atmosphere at 50° C. for 155 days, relative to a value in an initial state.

16. The connection terminal according to claim 14, wherein
a maximum retention force in removal of the connection terminal inserted into the through-hole having a Sn layer in the inner periphery is suppressed to 20% or less in terms of amount of change after the connection terminal is left in the atmosphere at 50° C. for 155 days, relative to a value in an initial state.

17. The connection terminal according to claim 14, wherein
an adhesion peak height in removal of the connection terminal inserted into the through-hole having a Sn layer in the inner periphery is suppressed to 35% or less in terms of amount of change after the connection terminal is left in the atmosphere at 50° C. for 155 days, relative to a value in an initial state.

18. A method for producing a metal material, wherein the metal material according to claim 1 is produced by
forming a metal layer including Ag and Sn, on a surface of a substrate, and
thereafter heating the resultant at a temperature equal to or more than the melting point of Sn.

19. The method for producing a metal material according to claim 18, wherein
not only a metal layer including Ag and Sn is formed in a first region as a partial region of the surface of the substrate,
but also a Sn layer or a Sn alloy layer containing Ag only as an unavoidable impurity is formed in a second region as a different region from the first region of the surface of the substrate, and
thereafter both the first region and the second region are heated to a temperature equal to or more than the melting point of Sn.
